(19) United States
(12) Patent Application Publication
(10) Pub. No.: US 2013/0124674 A1
(43) Pub. Date: May 16, 2013

(54) COMPUTER SYSTEM AND DATA MIGRATION METHOD

(71) Applicants: Shinya Matsumoto, Yokohama (JP); Takaki Nakamura, Ebina (JP); Keiichi Matsuzawa, Yokohama (JP)

(72) Inventors: Shinya Matsumoto, Yokohama (JP); Takaki Nakamura, Ebina (JP); Keiichi Matsuzawa, Yokohama (JP)

(73) Assignee: Hitachi, Ltd.

(21) Appl. No.: 13/322,329

(22) PCT Filed: Nov. 15, 2011
(86) PCT No.: PCT/JP2011/006367

§ 371 Date: Nov. 23, 2011

(51) Int. Cl. G06F 15/16

(52) U.S. Cl. 709/217

(57) ABSTRACT

Proposed are a computer system and a data migration method which enable an improved response performance to a data access request from the user.

A client computer or an application on a second file server transmits an access request for access to data stored in a first storage area to a second file server and, if an access request from the client computer is received, the second file server migrates data from a first storage area of a first storage apparatus to a second storage area of a second storage apparatus and, if an access request from the application on the second file server is received, data is migrated from the first storage area of the first storage apparatus to a third storage area of a third storage apparatus.

### TECHNICAL FIELD

The present invention relates to a computer system and a data migration method and is, for example, suitably applied to a computer system and a data migration method which are configured from a storage apparatus comprising storage areas in a tier configuration and a file server which optionally stores data according to characteristics of the storage areas.

### BACKGROUND ART

Storage devices with a variety of characteristics have been disclosed in recent years, there being variations in the performance of storage devices constituting the storage apparatuses in particular. Typically, high performance storage devices are high cost and hence a large capacity cannot be reserved, whereas low performance storage devices are low cost and therefore a large capacity can be reserved. Hence, conventionally, in order to reduce the costs required to construct a computer system, a hierarchical storage technology is proposed which uses a combination of a plurality of storage devices of varying performance.

In a computer system adopting this kind of hierarchical storage technology, the frequency of usage of each of the data stored in the storage apparatus is monitored at all times, and data with a high usage frequency is stored and held in storage areas provided by high performance storage devices, while data with a low usage frequency is stored and held in storage areas provided by low performance storage devices.

Further, in a computer system to which this hierarchical storage technology is applied, in a case where a system is repressed due to degradation and for other reasons and where a newly introduced storage apparatus is unable to acquire hierarchical information of an existing storage apparatus, there is a problem in that data which is stored in the existing storage apparatus cannot be migrated to a storage area of a suitable tier in the newly introduced storage apparatus.

As means for resolving this problem, PTL1, for example, discloses a data migration method which determines the data migration destination tier on the basis of attributes which are configured from the data types of individual data stored in the existing storage apparatus, the final date and time of access to this data, and storage destination information, and based on a user-configured [data] moving condition.

However, the data migration method which is disclosed in PTL1 halts or prolongs user access to data being migrated and hence there is a problem in that, if there is a large amount of data to be migrated, the user is unable to access the data for a long time.

As means for solving such problems, PTL2, for example, discloses a data migration method which makes it possible to perform data migration while barely stopping user data access by using an apparatus known as a name space server which relays communications between the user and file server.

The name space server comprises a function for controlling an existing storage apparatus and a new storage apparatus whereby, in cases where access is requested by the user during data migration and cases where the access target data has been migrated to the new storage apparatus, data is supplied from the new storage apparatus which is the migration destination to the user, and in cases where the access target data has not yet been stored in the new storage apparatus, data is supplied to the user from the existing storage apparatus.

### CITATION LIST

Patent Literature
PTL 1: Japanese Published Unexamined Patent Application No. 2010-257095A
PTL 2: U.S. Patent Publication No. 7937453B1

### SUMMARY OF INVENTION

### Technical Problem

However, according to the method disclosed in the foregoing PTL2, the data stored in the existing storage apparatus is stored in the storage apparatus that is preconfigured by the system administrator. Therefore, when data is migrated to the storage apparatus that is newly introduced from the existing storage apparatus, the data stored in the high performance storage area in the existing storage apparatus is stored in the high performance storage area in the newly introduced storage apparatus and the data stored in the low performance storage area in the existing storage apparatus is stored in a low performance storage area in the newly introduced storage apparatus.

For this reason, high usage frequency data is stored in a high performance storage area at the migration destination even when the user is not awaiting the completion of data migration and there is little need to respond quickly, and low usage frequency data is migrated to a low performance storage area at the migration destination even when the user is awaiting the completion of data migration and a high speed response is required. This results in a drop in response performance for data for which the user requires a high-speed response, and data not requiring a high speed response is stored in a storage apparatus which comprises a high speed and high cost storage area, and hence there is a problem in that the overall costs of the computer system increase.

The present invention was conceived in view of the above, and proposes a computer system and a data migration method which enable an improved response performance to a data access request from the user.

### Solution to Problem

In order to achieve the foregoing object, the present invention comprises a client computer; a first file server which reads and writes data from/to a first storage apparatus which comprises one or more first storage areas; second file server which reads and writes data from/to a second storage apparatus which comprises one or more second storage areas; and a third file server which reads and writes data to a third storage apparatus which comprises a third storage area constituting a tiered structure together with the second storage area, wherein the client computer or an application on the second file server transmits an access request, for access to the data stored in the first storage area, to the second file server, wherein the second file server migrates the data from the first storage area of the first storage apparatus to the second storage area of the second storage apparatus if the access request from the client computer is received, and wherein the second file server migrates data from the first storage area of the first storage apparatus to the third storage area of the third storage apparatus if the access request from the application on the second file server is received.

Furthermore, the present invention provides a data migration method of a computer system which comprises a client computer, a first file server that reads and writes data from/to a first storage apparatus which comprises one or more first storage areas, a second file server that reads and writes data from/to a second storage apparatus which comprises one or more second storage areas, and a third file server that reads and writes data from/to a third storage apparatus which comprises a third storage area constituting a tiered structure together with the second storage area, the data migration method comprising a first step in which the client computer or the application on the second file server transmits an access request, to access the data stored in the first storage area, to the second file server; and a second step in which, if the access request from the client computer is received, the second file server migrates the data from the first storage area of the first storage apparatus to the second storage area of the second storage apparatus and, if the access request from the application on the second file server is received, the second file server migrates the data from the first storage area of the first storage apparatus to the third storage area of the third storage apparatus.

### Advantageous Effects of Invention

The present invention makes it possible to realize a computer system and data migration method which enable an improved response performance to a data access request from the user.

### BRIEF DESCRIPTION OF DRAWINGS

FIG. 1 is a block diagram showing an overall configuration of a computer system according to a first embodiment.

FIG. 2 is a block diagram showing an overall configuration of a migration source file server.

FIG. 3 is a block diagram showing an overall configuration of a storage apparatus.

FIG. 4 is a block diagram showing an overall configuration of a migration destination frontend file server.

FIG. 5 is a block diagram showing an overall configuration of a storage apparatus.

FIG. 6 is a block diagram showing an overall configuration of a migration destination backend file server.

FIG. 7 is a block diagram showing an overall configuration of a storage apparatus.

FIG. 8 is a block diagram showing a configuration example of a computer system according to the first embodiment.

FIG. 9 is a block diagram showing an overall configuration of a file server program.

FIG. 10 is a block diagram showing an overall configuration of a file system program.

FIG. 11 is a block diagram showing an overall configuration of a data moving program.

FIG. 12 is a block diagram showing an overall configuration of a data migration program.

FIG. 13 is a conceptual diagram showing a configuration of a tier moving policy definition table.

FIG. 14 is a conceptual diagram showing a configuration of a tier configuration definition table.

FIG. 15 is a conceptual diagram showing a configuration of a migration policy definition table.

FIG. 16 is a conceptual diagram showing a configuration of a migration configuration definition table.

FIG. 17 is a conceptual diagram showing a configuration of a migration policy configuration screen.

FIG. 18 is a flowchart showing a processing routine for access request execution processing.

FIG. 19 is a flowchart showing a processing routine for data migration processing.

FIG. 20 is a flowchart showing a processing routine for migration destination tier determination processing.

FIG. 21 is a flowchart showing a processing routine for file migration processing.

FIG. 22 is a flowchart showing a processing routine for directory migration processing.

FIG. 23 is a flowchart showing a processing routine for stub file creation processing.

FIG. 24 is a flowchart showing a processing routine for metadata update processing.

FIG. 25 is a flowchart showing a processing routine for data moving processing.

FIG. 26 is a flowchart showing a processing routine for moving determination processing.

FIG. 27 is a flowchart showing a processing routine for file moving processing.

FIG. 28 is a flowchart showing a processing routine for directory duplication processing.

FIG. 29 is a block diagram showing a configuration example of a computer system according to a second embodiment.

FIG. 30 is a block diagram showing a schematic configuration of a data migration program.

FIG. 31 is a block diagram showing a configuration of a migration policy definition table.

FIG. 32 is a block diagram showing a configuration of a bandwidth information table.

FIG. 33 is a conceptual diagram showing a configuration of a migration policy configuration screen.

FIG. 34 is a flowchart showing a processing routine for data migration processing.

FIG. 35 is a flowchart showing a processing routine for execution determination processing.

### DESCRIPTION OF EMBODIMENTS

An embodiment of the present invention will be described in detail hereinbelow with reference to the drawings.

### (1) First Embodiment

(1-1) Configuration of a Computer System According to this Embodiment

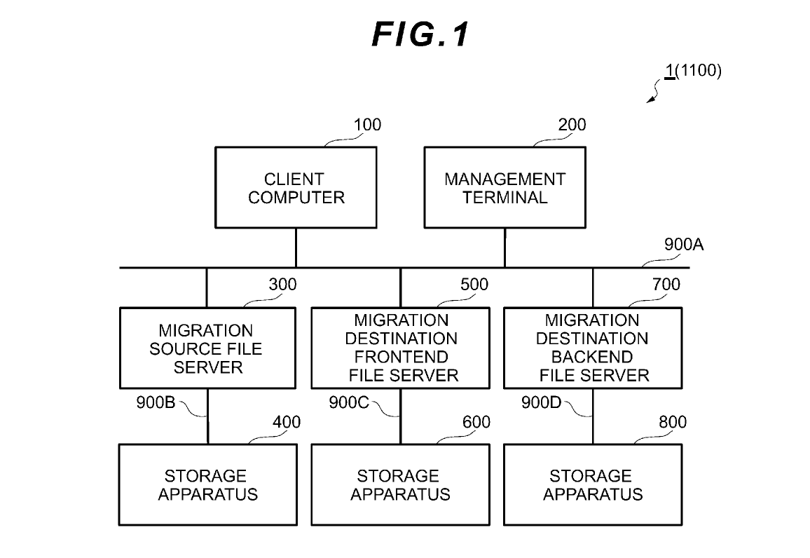

In FIG. 1, 1 generally denotes a computer system according to this embodiment. This computer system 1 is configured comprising a client computer 100, a management terminal 200, a migration source file server 300, a migration source storage apparatus 400, migration destination frontend file server 500, a migration destination frontend storage apparatus 600, a migration destination backend file server 700, and a migration destination backend storage apparatus 800.

The client computer 100, the management terminal 200, a migration source file server 300, a migration destination frontend file server 500 and a migration destination backend file server 700 are interconnected via a network 900A such as a LAN (Local Area Network). Further, the migration source file server 300 and migration source storage apparatus 400, the migration destination frontend file server 500, the migration destination frontend storage apparatus 600, the migration destination backend file server 700 and the migration destination backend storage apparatus 800 are each connected via SANs (Storage Area Networks) or other types of networks 900B to 900D.

Note that, in the case of this embodiment, the migration destination frontend file server 500 and the migration destination backend file server 600 are server apparatuses which are newly introduced to the computer system 1 instead of the existing migration source file server 300 and the migration destination frontend storage apparatus 600 and the migration destination backend storage apparatus 800 are new storage apparatuses which are newly introduced to the computer system 1 in place of the existing migration source storage apparatus 400. The storage areas respectively provided by the migration destination frontend storage apparatus 600 and the migration destination backend storage apparatus 800 form a hierarchical structure and the data stored in the migration source storage apparatus 400 is migrated by being divided between storage areas provided by the migration destination frontend storage apparatus 600 and the migration destination backend storage apparatus 800.

The client computer 100 is a terminal apparatus used by the user and is configured from a personal computer or the like, for example. The client computer 100 is configured comprising a CPU (Central Processing Unit), not shown, and an information processing resource such as memory. The client computer 100 accesses the migration source file server 300, the migration destination frontend file server 500 or the migration destination backend file server 800 in response to a request from the user or a program installed on the client computer 100 and reads and writes required data from/to the migration source storage apparatus 400, the migration destination frontend storage apparatus 600 or the migration destination backend storage apparatus 800.

The management terminal 200 is a computer device which is used to manage the whole computer system 1 and comprises information input devices, not shown, such as a keyboard, a switch, a pointing device and/or a microphone, and information output devices, not shown, such as a monitor display and/or a speaker.

The management terminal 200 collects various information relating to the migration source storage apparatus 400, the migration destination frontend storage apparatus 600, and the migration destination backend storage apparatus 800 from the migration source file server 300, the migration destination frontend file server 500, and the migration destination backend file server 700 or the like, and performs the required configuration on the migration source file server 300, the migration destination frontend file server 500, and the migration destination backend file server 700 in response to the display of the collected information and an instruction from the system administrator.

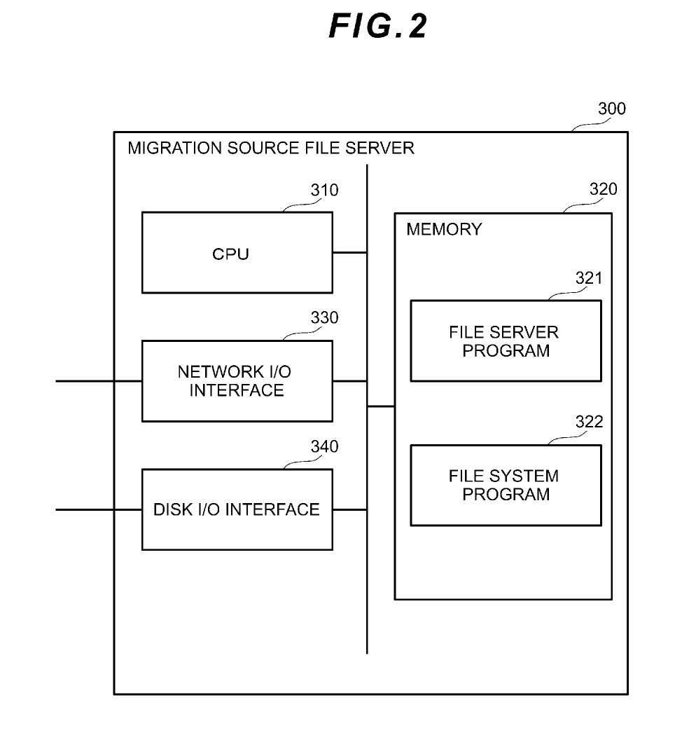

The migration source file server 300 is a server apparatus with a built-in file sharing service function which supplies file sharing services to the client computer 100 and reads and writes data from/to the migration source storage apparatus 400 on the basis of an access request from the client computer 100. As shown in FIG. 2, the migration source file server 300 is configured comprising a CPU 310, a memory 320, a network I/O interface 330, and a disk I/O interface 340.

The CPU 310 is a processor that governs overall operation control of the migration source file server 300. Furthermore, the memory 320 is configured from a semiconductor memory such as a DRAM (Dynamic Random Access Memory), for example, and, in addition to being used to store various control programs and various control information, is used as the working memory of the CPU 310. The file server program 321 and the file system program 322, described subsequently, are also held stored in the memory 320. Furthermore, as a result of the CPU 310 executing the control program stored in the memory 320, various processing is executed for the whole migration source file server 300.

The network I/O interface 350 is an adapter for connecting the migration source file server 300 to the network 900 and which performs protocol control during communications with the client computer 100, the management terminal 200, or the migration destination frontend file server 500. Further, the disk I/O interface 360 is an adapter for connecting the migration source file server 300 to the migration source storage apparatus 400 and performs protocol control during communications with the migration source storage apparatus 400.

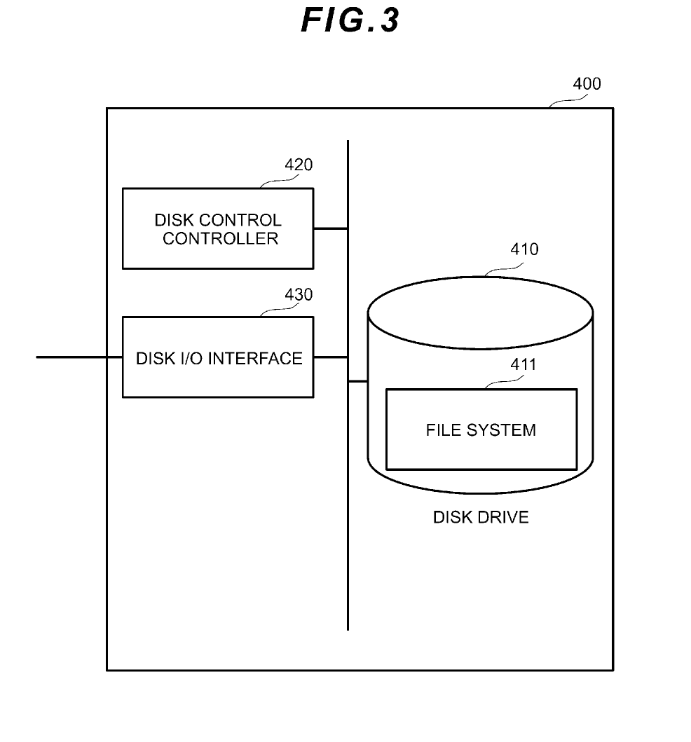

The migration source storage apparatus 400 is a storage apparatus which provides storage areas for reading and writing data from/to the migration source file server 300 and, as shown in FIG. 3, is configured comprising a disk drive 410, a disk control controller 420, and a disk I/O interface 430.

The disk drive 410 is configured from, for example, a high cost disk such as an FC (Fibre Channel) disk or SCSI (Small Computer System Interface) disk or a low cost disk such as a SATA (Serial AT Attachment) disk. A RAID group is configured from one or more disk drives 410 and one or more volumes are defined in a physical storage area provided by each of the disk drives 410 which constitute a single RAID group.

The disk drive 410 stores and holds the file system 411, and data which is read from and written to the disk drive 410 is managed in file units as a result of the disk control controller 420 executing the file system 411 stored in the disk drive 410.

The disk control controller 420 is a system component which controls the whole migration source storage apparatus 400 and reads and writes data from/to the disk drive 410 in block units in response to a data I/O request from the migration source file server 300.

The disk I/O interface 430 is an adapter for connecting the migration source storage apparatus 400 to the migration source file server 300 and performs protocol control during communications with the migration source file server 300.

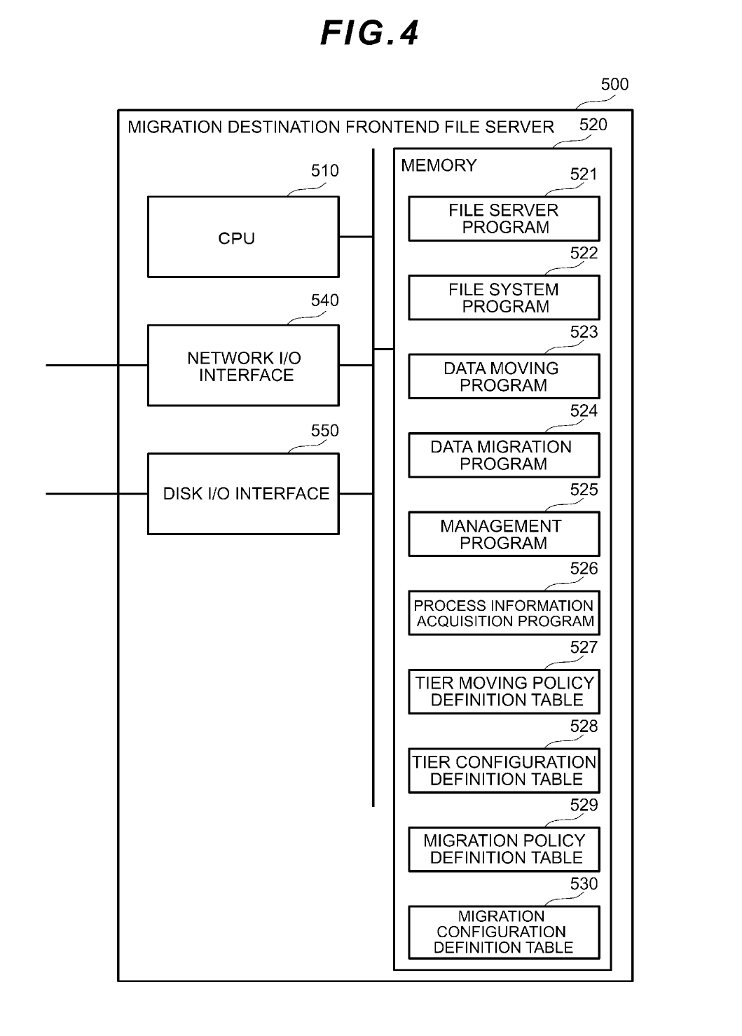

Meanwhile, the migration destination frontend file server 500 is a server apparatus which provides file sharing services to the client computer 100 and, as shown in FIG. 4, is configured comprising a CPU 510, a memory 520, a network I/O interface 540, and a disk I/O interface 550.

The memory 520 is configured from semiconductor memory such as a DRAM, for example, and, in addition to being used to store various control programs and various control information, is also used as working memory of the CPU 310. Various control programs such as a file server program 521, a file system program 522, a data moving program 523, a data migration program 524, a management program 525, and a process information acquisition program 526, and various control information such as a tier moving policy definition table 527, a tier configuration definition table 528, a migration policy definition table 529, and a migration configuration definition table 530, which are described subsequently, are also stored and held in the memory 520. The details of the control program and control configuration information will be described subsequently.

Note that the CPU 510, the network I/O interface 540 and the disk I/O interface 550 have the same function as the CPU 310, the network I/O interface 330, and the disk I/O interface 340 of the migration source file server 300, and hence a detailed description is omitted.

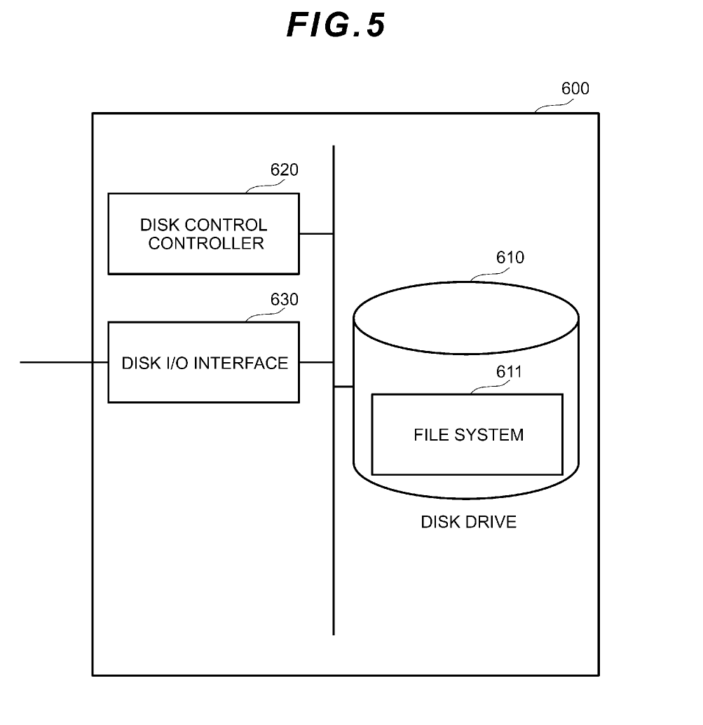

The migration destination frontend storage apparatus 600 is an apparatus which supplies storage area for reading and writing data from/to the migration destination frontend file server 500 and, as shown in FIG. 5, is configured comprising a disk drive 610, a disk control controller 620, and a disk I/O interface 630.

The disk driver 610 is configured from a high cost disk such as an FC disk or SCSI disk, for example, and stores data and the like which requires a high speed response to the client computer 100. A RAID group is configured by one or more disk drives 810, and one or more volumes are defined in a physical storage area supplied by each of the disk drives 810 which constitute a single RAID group.

Further, the disk drive 610 stores and holds a file system 611 and data which is read and written from/to the disk drive 610 as a result of the disk control controller 620 executing the file system 611 stored in the disk drive 610 is managed in file units.

The disk control controller 620 is a system component which controls the whole migration destination frontend storage apparatus 600 and reads and writes data in block units, for example, from/to the disk drive 610 on the basis of a data I/O request from the migration destination frontend file server 500.

The disk I/O interface 630 is an adapter for connecting the migration destination frontend storage apparatus 600 to the network 900 and performs protocol control during communications with the migration destination frontend file server 500.

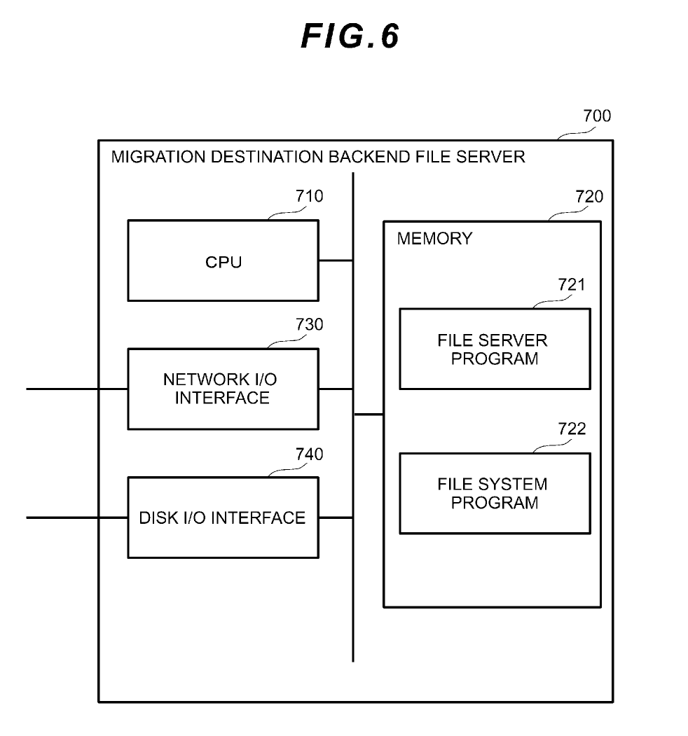

Meanwhile, the migration destination backend file server 700 is a computer apparatus which provides file sharing services to the client computer 100 and, as shown in FIG. 6, is configured comprising a CPU 710, a memory 720, a network I/O interface 730, and a disk I/O interface 740.

The CPU 710, the memory 720, the network I/O interface 730 and the disk I/O interface 740 have the same function as the CPU 310, the memory 320, the network I/O interface 330, and the disk I/O interface 340 of the migration destination frontend file server 500 and hence a detailed description is not included here.

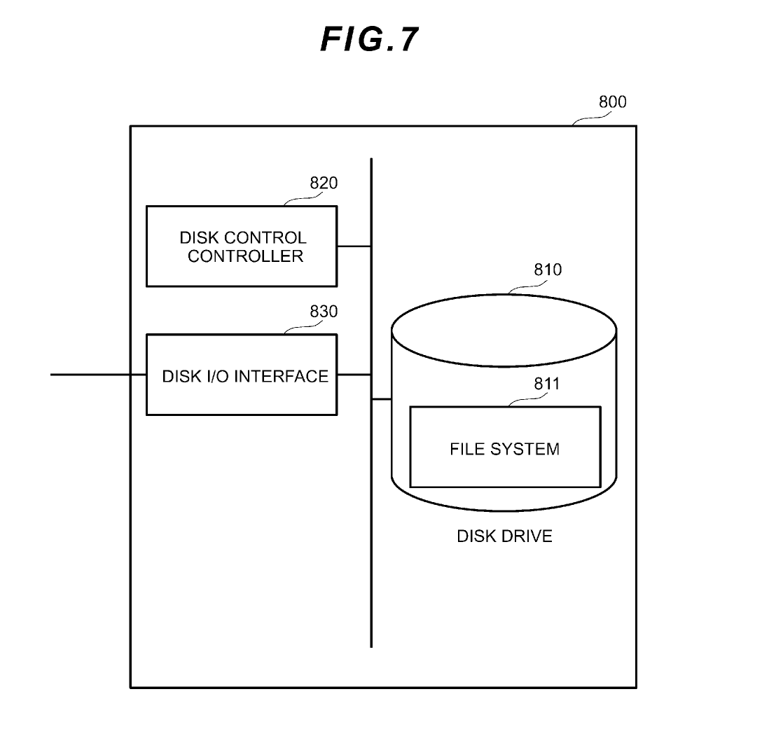

The migration destination backend storage apparatus 800 is an apparatus for supplying storage area for read and writing data from/to the migration destination backend file server 700 and, as shown in FIG. 7, is configured comprising a disk drive 810, a disk control controller 820, and a disk I/O interface 830.

The disk drive 810 is configured from a low cost disk such as a SATA disk, for example, and stores data for which a high speed response to the client computer 100 is not required. A single RAID group is configured from one or more disk drives 810 and one or more volumes are defined in a physical storage area provided by each of the disk drives 810 forming the single RAID group.

Furthermore, the disk drive 810 stores and holds a file system program 811 and, as a result of the disk control controller 820 executing the file system program 811 stored in the disk drive 810, the data read from and written to the disk drive 810 is managed in file units.

The disk control controller 820 is a system component which controls the whole migration destination backend storage apparatus 800 and which reads and writes data in block units, for example, from/to the disk drive 710 on the basis of a data I/O request from the migration destination backend file server 700.

The disk I/O interface 830 is an adapter for connecting the migration destination backend storage apparatus 800 to the network 900 and which performs protocol control during communications with the migration destination backend file server 700.

(1-2) Data Migration and Moving Function According to this Embodiment

(1-2-1) Overview and Logical Configuration of Computer System

A data migration and moving function which is installed in a computer system 1 will be described next. In the case of the computer system 1 according to this embodiment, one characteristic is that it is determined whether data access to the data stored in the migration source storage apparatus 400 is required by the migration destination frontend file server 500 or a user requirement, and in a case where the request is from the migration destination frontend file server 500, the access target data is migrated from the migration source storage apparatus 400 to the migration destination backend storage apparatus 800, whereas if the request is from the user, the data is migrated to the migration destination frontend storage apparatus 600.

Furthermore, with the computer system 1, similarly one characteristic is that in a case where there is no data access to the data stored in the migration destination frontend storage apparatus 600 for a fixed period, for example, the data is migrated from the migration destination frontend storage apparatus 600 to the migration destination backend storage apparatus 800 according to a predetermined policy.

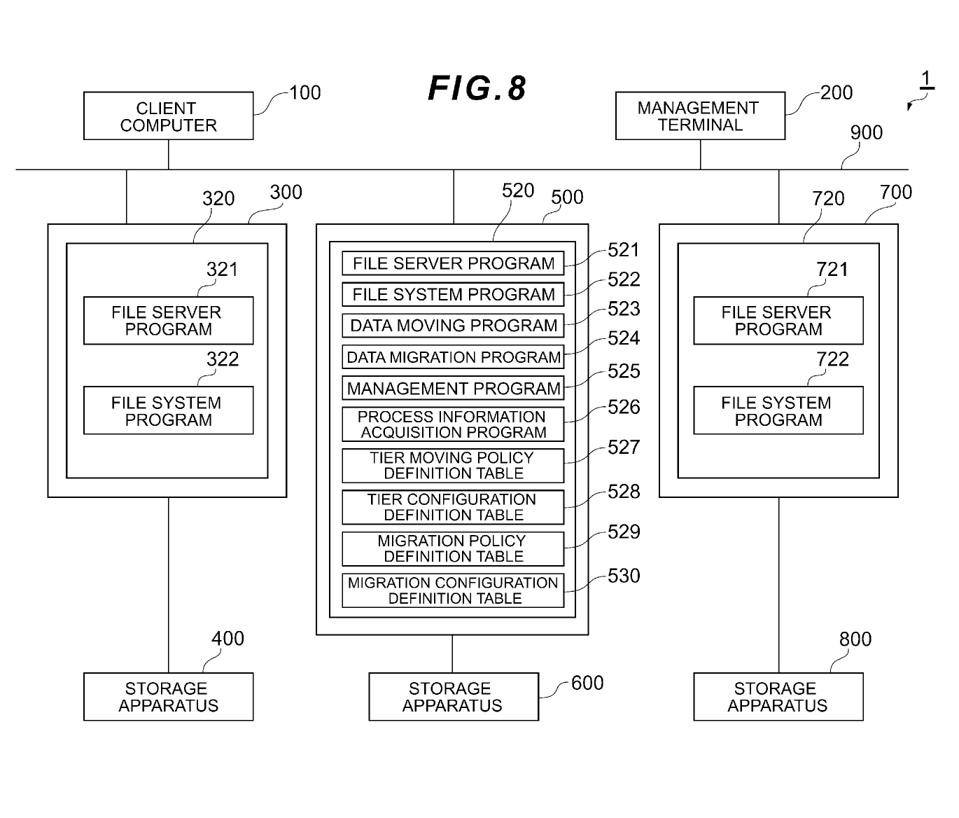

As means for executing the foregoing data migration and moving function according to this embodiment, the memory 320 of the migration source file server 300 stores the file server program 321 and file system program 322, as shown in FIG. 8.

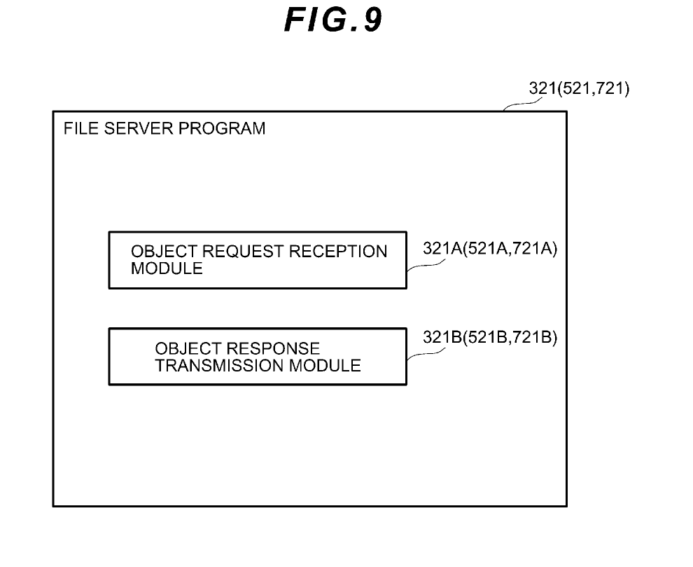

The file server program 321 is a program for causing the migration source file server 300 to function as a file server and, as shown in FIG. 9, is configured from an object request reception module 321A and an object response transmission module 321B.

The object request reception module 321A is a module which is executed when a file operation request, issued by the client computer 100 or an application program (not shown) installed on the migration destination frontend file server 500, is received, and which transfers this file operation request to the file system program 322. Note that there are seven file operation requests which are supplied by the client computer 100 or this application program, namely, a file creation request, a directory creation request, an object metadata read request, an object metadata write request, a data read request, a data write request and a data deletion request.

The object response transmission module 321B is a module which is executed upon receipt of the results of processing a file operation request transmitted by the file system program 322 (hereinafter called the file operation processing result) as described subsequently, and which transfers the received file operation processing result to the client computer 100 or the application program.

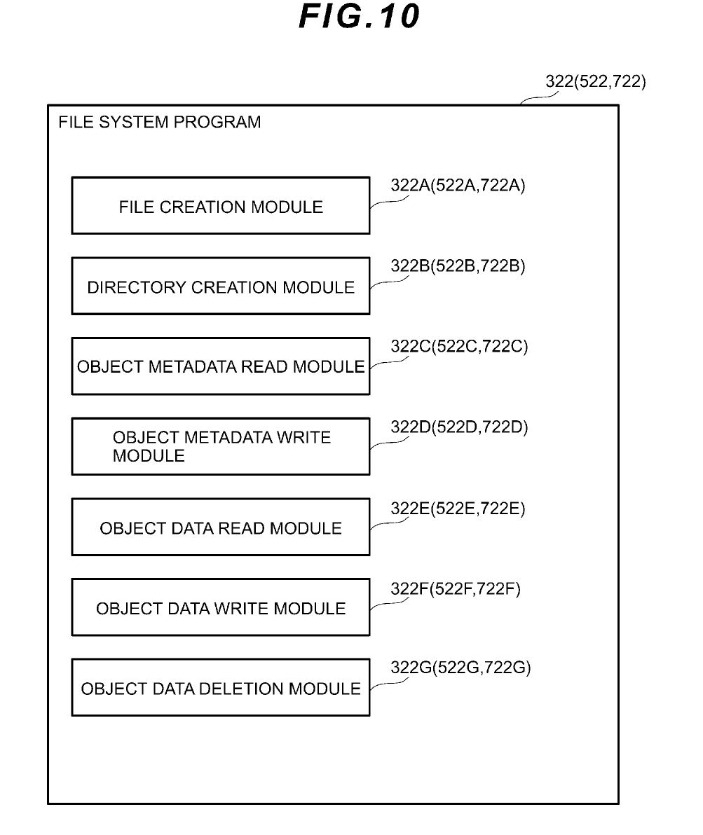

Furthermore, the file system program 322 is a program which executes a file operation request which is from the client computer 100 or an application program installed on the migration destination frontend file server 500 and which is transferred via the object request reception module 321A of the file server program and, as shown in FIG. 10, is configured from a file creation module 322A, a directory creation module 322B, an object metadata read module 322C, an object metadata write module 322D, an object data read module 322E, an object data write module 322F, and an object data deletion module 322G.

Among these modules, the file creation module 322A is a module which is executed when a file creation request is supplied as a file operation request. The file creation module 322A creates a new file in the path (IP address and file system path) designated in the file creation request and transmits a determination of whether the processing has succeeded to the file server program 321 as the foregoing file operation processing result.

The directory creation module 322B is a module which is executed when a directory creation request is supplied as this file operation request. The directory creation module 322B creates a directory in a path (IP address and file system path) which is designated by the directory creation request and transmits a determination of whether the processing has succeeded to the file server program 321 as the foregoing file operation processing result.

The object metadata read module 322C is a module which is executed when an object metadata read request is supplied as this file operation request. The object metadata read module 322C reads the object attribute information (hereinafter called metadata) which exists in a path designated by the object metadata read request. Furthermore, the object metadata read module 322C subsequently transmits a determination of whether this processing has been succeeded and, if the processing has succeeded, also the read metadata to the file server program 321 as the file operation processing result.

The object metadata write module 322D is a module which is executed when an object metadata write request is supplied as this file operation request. The object metadata write module 322D writes the designated metadata to the object that exists in the path designated in the object metadata write request and transmits a determination of whether this processing has succeeded to the file server program 321 as the foregoing file operation processing result.

The object data read module 322E is a module which is executed when an object data read request is supplied as this file operation request. The object data read module 322E reads object data (hereinafter called object data) in the path designated by the object data read request. More specifically, the object data read module 322E reads the data of parts other than the file metadata if this object is a file. In addition, the object data read module 322E reads an object path list which is stored in the directory if this object is a directory. Further, the object data read module 322E subsequently transmits a determination of whether this object data read processing has succeeded and if the read processing has succeeded, transmits the object data thus read to the file server program 321 as the file operation processing result.

The object data write module 322F is a module which is executed when the object data write request is supplied as the file operation request. The object data write module 322F writes the designated object data to the object that exists in the path designated by the object data write request. More specifically, if this object is a file, the object data write module 322F writes the file data to the path designated by the object data write request. Furthermore, if the object is a directory, the object data write module 322F adds an entry to the directory and renames the entry. The object data write module subsequently transmits a determination of whether this processing has succeeded to the file server program 321 as the file operation processing result.

The object data deletion module 322G is a module which is executed when an object data deletion request is supplied as this file operation request. The object data deletion module 322G deletes object data that exists on the path designated by the object data deletion request. Thereupon, the object data deletion module 322G deletes only the main part of the object and does not delete the object metadata. Further, the object data deletion module 322G subsequently transmits a determination of whether this processing has succeeded to the file server program 321 as the foregoing file operation processing result.

Meanwhile, the memory 520 of the migration destination frontend file server 500 stores, as means for realizing the data migration and moving function according to this embodiment, various control programs such as a file server program 521 and a file system program 522, a data moving program 523, a data migration program 524, a management program 525, and a process information acquisition program 526 as well as various control information, namely, a tier moving policy definition table 527, a tier configuration definition table 528, a migration policy definition table 529, and a migration configuration definition table 530.

Among these programs, the file server program 521 and the file system program 522 have the same functions as the file server program 321 and the file system program of the migration source file server 300 and therefore will not be described here.

Furthermore, the data moving program 523 is a program for performing data migration from the migration destination frontend storage apparatus 600 to the migration destination backend storage apparatus 800, and the data migration program 524 is a program for performing data migration from the migration source storage apparatus 400 to the migration destination frontend storage apparatus 600. Details of the data moving program 523 and the data migration program 524 will be provided subsequently.

The management program 525 stores and manages policies, in a predetermined table (hereinafter this is called a tier migration policy definition table), for data migration between the migration destination frontend storage apparatus 600 and the migration destination backend storage apparatus 800 collected by the management terminal 200. Furthermore, the management program 525 stores and manages, in a predetermined table (hereinafter called a migration policy definition table), policies for data migration between the migration source storage apparatus 400 and migration destination frontend storage apparatus 600 or the migration source storage apparatus 400 and migration destination backend storage apparatus 800.

The process information acquisition program 526 is a program for acquiring management information (user ID and process name) for processing which is executed on a migration destination frontend file server 500 by means of a data access request and data migration request which are received from the client computer 100.

The tier moving policy definition table 527 is a table which is used to manage policies which are migration conditions for when an object is migrated from the migration destination frontend storage apparatus 600 to the migration destination backend storage apparatus 800 and which are pre-registered in the migration destination frontend file server 500 via the management terminal 200 by the system administrator and, as shown in FIG. 13, the table is configured from a last access time threshold field 527A and placement destination tier field 527B.

Further, the last access time threshold field 527A stores a threshold for the last access time of access to a corresponding object that was pre-registered by the system administrator and the placement destination tier field 527B stores a corresponding object storage destination.

Hence, FIG. 13 shows that an object for which the last access time is “one week before” is stored in a storage area of a “tier 2” storage apparatus.

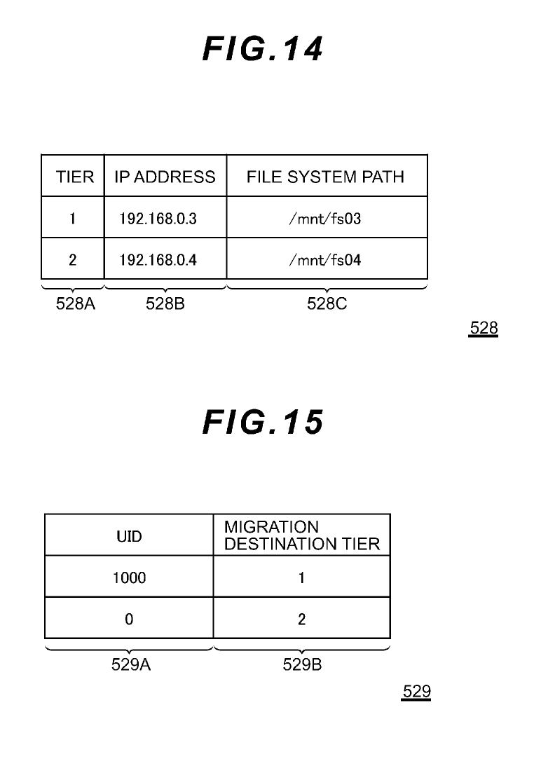

The tier configuration definition table 528 is a table which is used to manage the correspondence relationships between the storage area tiers of the storage apparatus and the IP addresses and file system paths assigned to the tiers, which are preconfigured by the system administrator and, as shown in FIG. 14, is configured from a tier field 528A, an IP address field 528B, and a file system path field 528C.

Further, the tier field 528A stores storage area tiers of the storage apparatus which are pre-registered by the system administrator. Furthermore, the IP address field 528B stores the IP address assigned to the corresponding storage area and the file system path field 528C stores a path which is assigned to the file system in the corresponding storage area.

Therefore, FIG. 14 shows that the file system path with the IP address “192.168.0.3” in the storage area of the tier “1” storage apparatus is “/mnt/fs03”.

The migration policy definition table 529 is a table which is used to manage policies which are migration conditions for when an object is migrated from the migration source file server 300 to the migration destination frontend file server 500 and which are pre-registered in the migration destination frontend file server 500 via the management terminal 200 by the system administrator and which, as shown in FIG. 15, are configured from a user ID field 529A and a migration destination tier field 529B.

Furthermore, the user ID field 529A stores users who issue access requests to the corresponding objects and user identifiers (user IDs) which are assigned to the migration destination frontend file server 500 and the migration destination tier field 529B stores the corresponding object storage destination.

Therefore, FIG. 15 shows that an object for which access is requested by a user with the user ID “1000” or the migration destination frontend file server 500 is stored in a tier “1” storage apparatus.

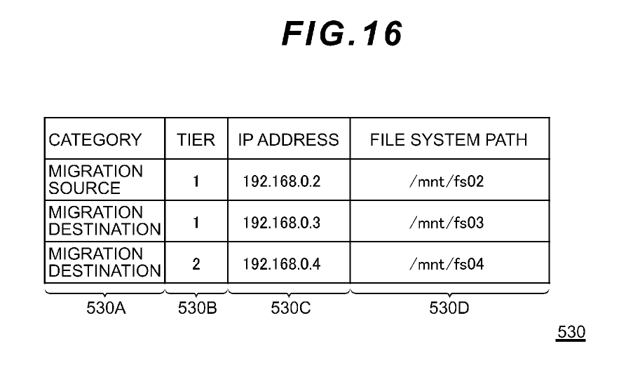

The migration configuration definition table 530 is a table which is used to manage correspondence relationships, preconfigured by the system administrator, between the storage area tiers of the storage apparatuses corresponding to the migration source file server 300, the migration destination frontend file server 500, and the migration destination backend file server 700 respectively and the IP addresses and file system paths which are assigned to the tiers and, as shown in FIG. 16, this table is configured from a category field 530A, a tier field 530B, an IP address field 530C, and a file system path field 530D.

Furthermore, the category field 530A stores file server type names and the tier field 530B stores storage area tiers of storage apparatuses which are pre-registered by the system administrator. Further, the IP address field 530C stores IP addresses which are assigned to the corresponding storage areas and the file system path field 530D stores paths which are assigned to file systems in the corresponding storage areas.

Hence, FIG. 16 shows that a file system path with the IP address “192.168.0.2” of a storage area of the tier “1” storage apparatus in the file server with the category “migration source” is “/mnt/fs02.”

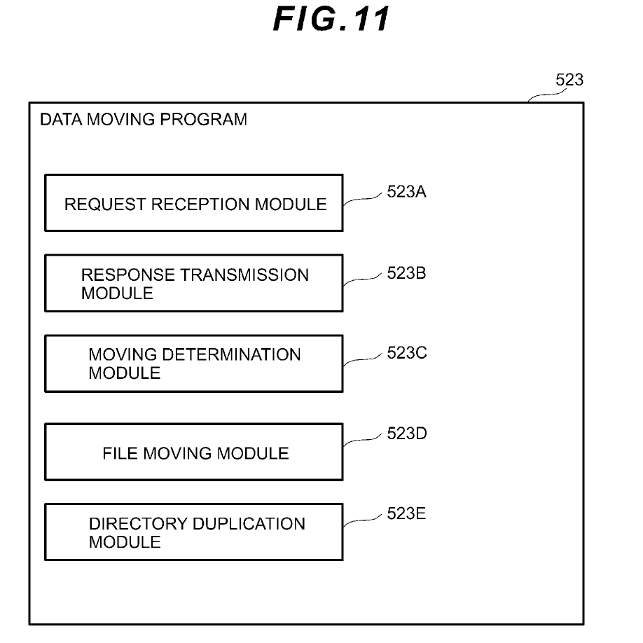

Note that FIG. 11 shows the detailed configuration of a data migration program. As shown in FIG. 11, the data moving program is configured comprising a request reception module 523A, a response transmission module 523B, a moving determination module 523C, a file moving module 523D, and a directory duplication module 523E.

The request reception module 523E is a module which is executed when the data moving program 523 receives the data moving request which is issued at regular intervals to the data moving program from an application program (not shown) which is installed on the migration destination frontend file server 500 and transfers the received data moving request to the moving determination module.

Furthermore, the response transmission module 523B is a module which is executed when the data moving processing by the data moving program 523 is complete and transmits the processing result of the data moving processing to the application on the migration destination frontend file server 500 which issued the data moving request.

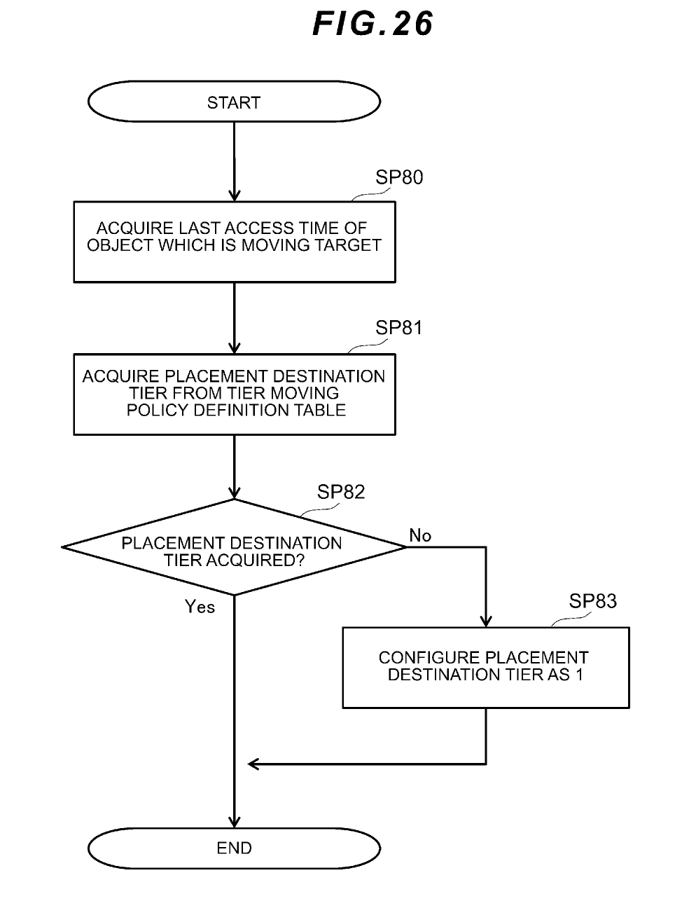

The moving determination module 523C is a module which is activated when the request reception module 523A receives the data moving request, and determines whether the moving target object which is designated by the data moving request should be migrated to the migration destination designated by the data moving request. The specific processing content of the determination processing which is executed by the moving determination module 523C will be described subsequently (see FIG. 26).

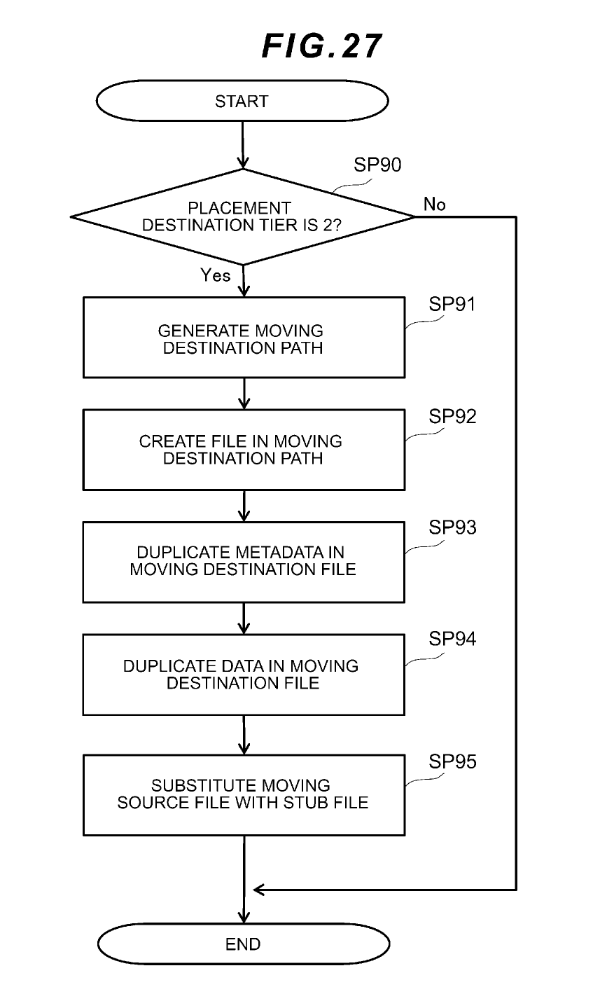

The file moving module 523D is a module that is determined by the moving determination module 523C when the moving target object designated by the data moving request should be moved and which is executed if the moving target object is a file. The file moving module migrates the moving target files to the migration destination backend file server 700 in this case, creates a stub file indicating the object moving destination, and overwrites the data of the object stored in the migration destination frontend storage apparatus 600 with the created stub file. The specific processing content of the file moving processing which is executed by the file moving module 523D will be described subsequently (see FIG. 27).

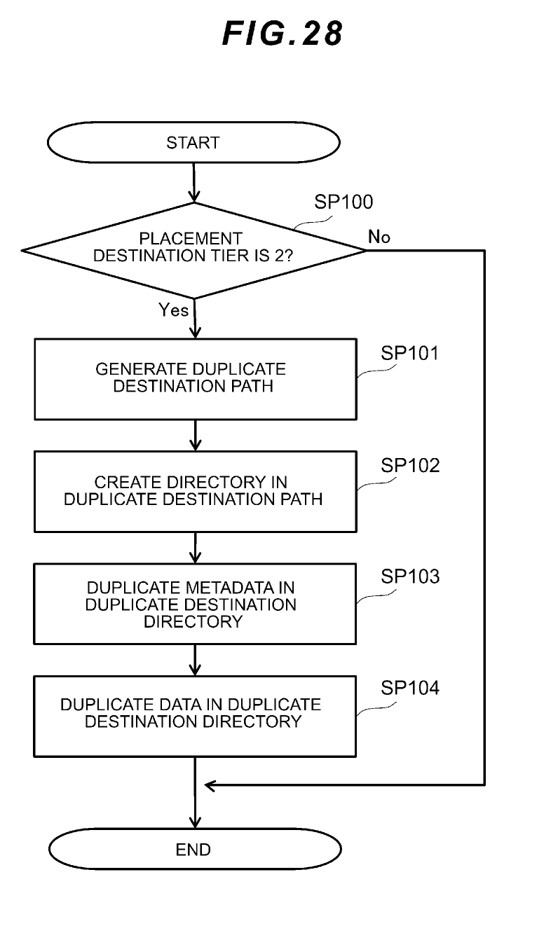

The directory duplication module 523E is a module that is determined by the moving determination module 523C when the moving target object designated by the data moving request should be moved and which is executed if the moving target object is a directory. The directory duplication module 523E duplicates the moving target directory in this case in the migration destination backend storage apparatus 800. The specific processing content of directory moving processing which is executed by the directory duplication module 523E will be described subsequently (see FIG. 28).

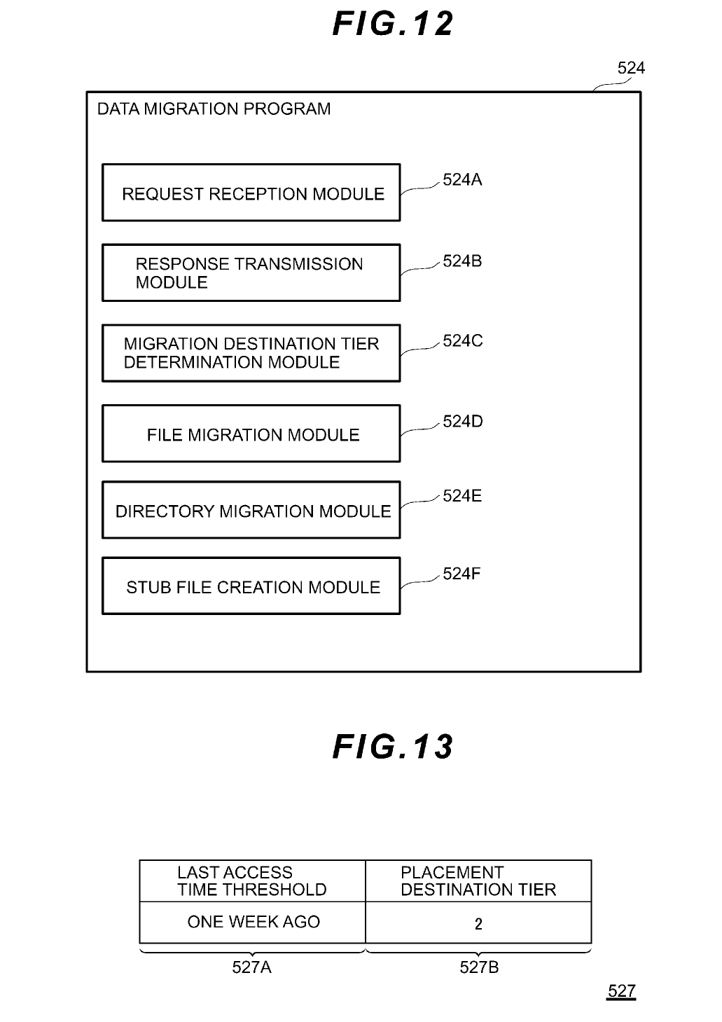

In addition, FIG. 12 shows the detailed configuration of the data migration program 524. As shown in FIG. 12, the data migration program 524 is configured comprising a request reception module 524A, a response transmission module 524B, a migration destination tier determination module 524C, a file migration module 524D, a directory migration module 524E, and a stub file creation module 524F.

The request reception module 524A is a module which is executed when an access request (write request or read request) from the client computer 100 for data that has not been migrated from the migration source storage apparatus to the migration destination frontend storage apparatus 600 or the migration destination backend storage apparatus 800 is supplied to the migration destination frontend file server 500 or when the data migration program 524 receives a data migration request which is issued at regular intervals to the data migration program 524 from an application program (not shown) installed on the migration destination frontend file server 500. The request reception module 524A transfers the received data migration request to the migration destination tier determination module 524C.

Further, the response transmission module 524B is a module which is executed when data migration processing by the data migration program 524 is complete and which transmits the processing result of the data migration processing to the application on the migration destination frontend file server 500 which issued the data migration request.

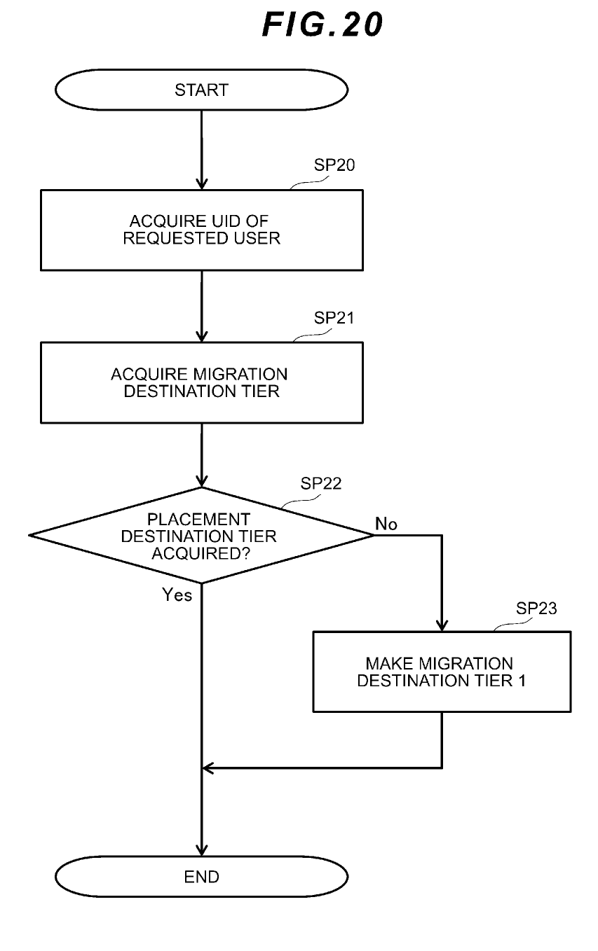

The migration destination tier determination module 524C is a module which is started up when the request reception module 524A receives a data migration request and which determines, based on a policy determined beforehand by the system administrator, the tier which is to serve as the migration destination of the migration target object designated by the data migration request. The specific processing content of the migration destination tier determination processing executed by the migration destination tier determination module 524C will be described next (see FIG. 20).

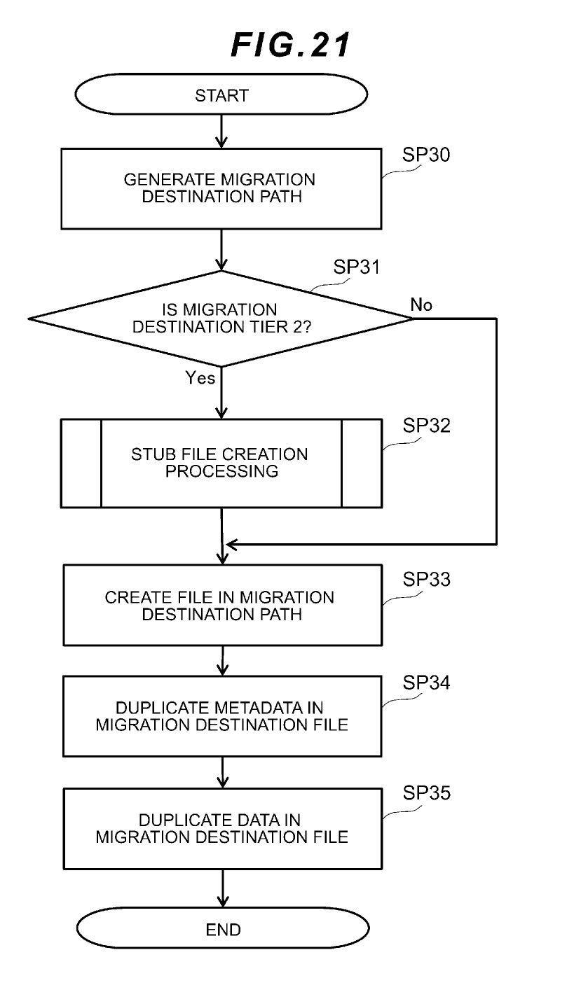

The file migration module 524D is a module which is started up after the migration destination for the migration target object is determined by the migration destination tier determination module 524C and if the migration target object is a file, and this module migrates the file from the migration source storage apparatus 400 to the migration destination frontend storage apparatus 600 or migration destination backend storage apparatus 800 which constitutes the tier determined by the migration destination tier determination module 524C. The specific processing content of the file migration processing executed by this file migration module 524D will be described subsequently (see FIG. 21).

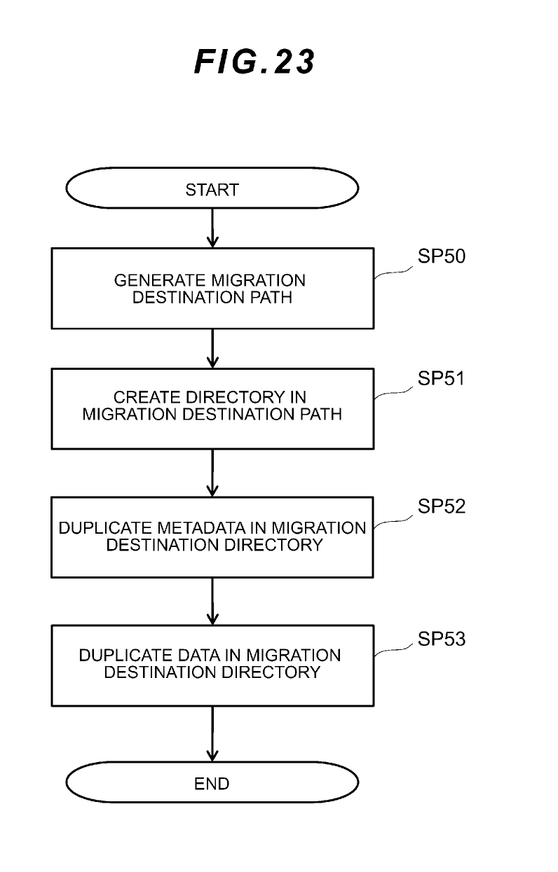

The directory migration module 524E is a module which is started up after the migration destination for the migration target object is determined by the migration destination tier determination module 524C and if the migration target object is a directory, and this module migrates the directory from the migration source storage apparatus 400 to the migration destination frontend storage apparatus 600 or migration destination backend storage apparatus 800 which constitutes the tier determined by the migration destination tier determination module 524C. The specific processing content of the directory migration processing executed by this directory migration module 524E will be described subsequently (see FIG. 23).

The stub file creation module 524F is a module which is executed after this file has been migrated by the file migration module 524D from the migration source storage apparatus 400 to the migration destination frontend storage apparatus 600 or migration destination backend storage apparatus 800 which constitutes the tier determined by the migration destination tier determination module 524C, and this module creates a stub file indicating the migration destination of the migration target object and stores the stub file in the migration destination frontend storage apparatus 600 via the migration destination frontend file server 500.

Meanwhile, the memory 720 of the migration destination backend file server 700 stores, as means for implementing the data migration and moving function according to this embodiment, a file server program 721 and a file system program 722. In this case, the file server program 721 and the file system program 722 have the same functions as the file server program 321 and the file system program 322 stored in the memory 320 of the migration source file server 300 and therefore will not be described in detail here.

(1-3) Migration Policy Configuration Screen

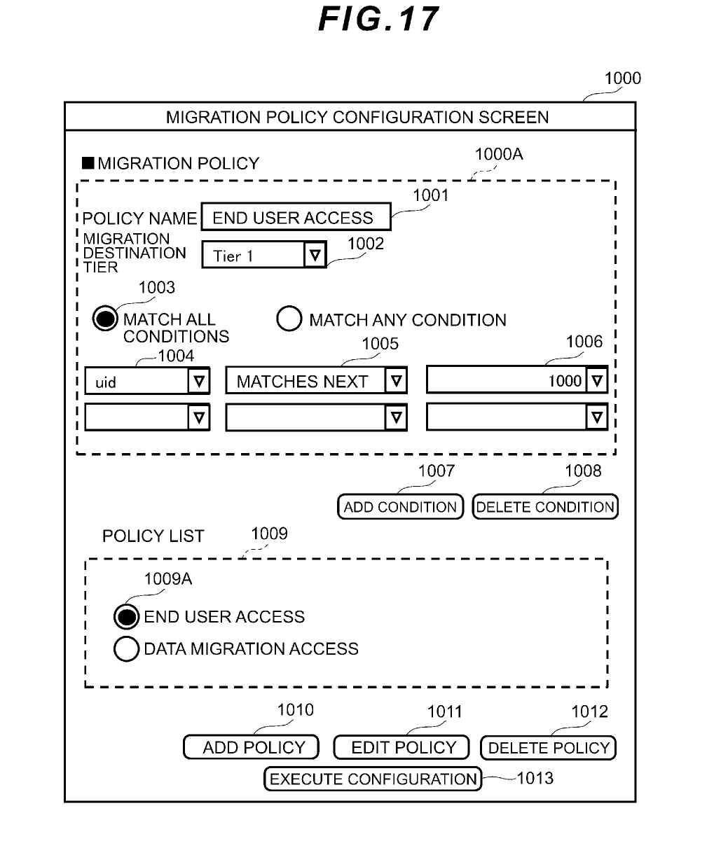

FIG. 17 shows an example of the configuration of a migration policy configuration screen 1000 which is displayed on an information output device (not shown) of the management terminal 200 as a result of the system administrator operating the management terminal 200. The system administrator uses the migration policy configuration screen 1000 to enable the creation of a new policy, which is a migration condition for when an object is migrated, on the migration destination frontend file server 500.

In reality, the migration policy display area 1000A of the migration policy configuration screen 1000 is provided with a policy name display area 1001, a migration destination tier display area 1002, a first radio button 1003, a first pulldown list display area 1004, a second pulldown list display area 1005, a numerical value or character string display area 1006, a condition addition execution button 1007, a condition deletion execution button 1008, a policy list display area 1009, a second radio button 1009A, a policy addition execution button 1010, a policy edit execution button 1011, a policy deletion execution button 1012, and a configuration execution button 1013.

The second radio button 1009A of the policy list display area 1009 is a radio button which is provided to correspond to the policy names respectively, and the policy addition execution button 1010 is an execution button for creating policy names which correspond to new policies which are displayed on the policy list display area 1009.

The policy edit execution button 1011 is an execution button for displaying policies stored in the memory 520 of the migration destination frontend file server 500 on the migration policy configuration screen 1000 in order to allow the system administrator to edit the policies and the policy deletion execution button 1012 is an execution button for deleting policy names from the policy list display area 1009.

The system administrator is thus able to select a policy name as a creation target by displaying a checkmark in the radio button 1009A corresponding to the desired policy name among the policy names displayed on the policy list display area 1009 and is then able to display the policy of the policy name selected in the migration policy display area 1000A on the migration policy configuration screen 1000 by clicking the policy edit execution button 1010.

Furthermore, the policy name display area 1001 of the migration policy display area 1000A is a display area for displaying the policy selected by the second radio button 1009A of the policy list display area 1009 and the migration destination tier display area 1002 is a display area for displaying the data migration destination tier.

In addition, the first radio button 1003 of the migration policy display area 1000A is a radio button provided so as to correspond to the condition in order to select “matches all conditions” or “matches any of the conditions.” The first pulldown list display area 1004 is a display area for displaying process names and command names executed on the migration destination frontend file server 500 together with the user IDs which are used when accessing the migration destination frontend file server 500.

The second pulldown list display area 1005 is a display area for displaying conditions such as “matches next value,” “does not match next value,” “greater than next value,” and “smaller than next value” and the numerical value or character string display area 1006 is a display area for displaying the user IDs, process names, and command names which are input by the system administrator.

The condition addition execution button 1007 is an execution button for adding a first pulldown list display area 1004, a second pulldown list display area 1005 and a numerical value or character string display area 1006 for adding a new condition to be displayed on the display area 1000A, and the condition deletion execution button 1008 is an execution button for deleting a first pulldown list display area 1004, the second pulldown list display area 1005 and the numerical value or character string display area 1006 from the display area 1000A. The configuration execution button 1013 is an execution button for storing newly created policies in the memory 520 in the migration destination frontend file server 500.

Thus, the example of FIG. 17, for example, shows a screen display example for when the system administrator creates a policy known as end user access in which storage is in the migration destination tier “Tier 1” when the user ID matches “1000.” Further, the policies can subsequently be created in the memory 520 of the migration destination frontend file server 500 by clicking the configuration execution button 1013.

(1-4) Various Processing Relating to the Data Moving Processing of the Computer System

The specific processing content relating to the data moving processing according to this embodiment will be described next. Note that although there will be cases hereinafter where the subject of the various processing is described as “programs,” it goes without saying that, in reality, the CPU of the migration destination frontend file server executes this processing on the basis of the “program.”

(1-4-1) Access Request Execution Processing

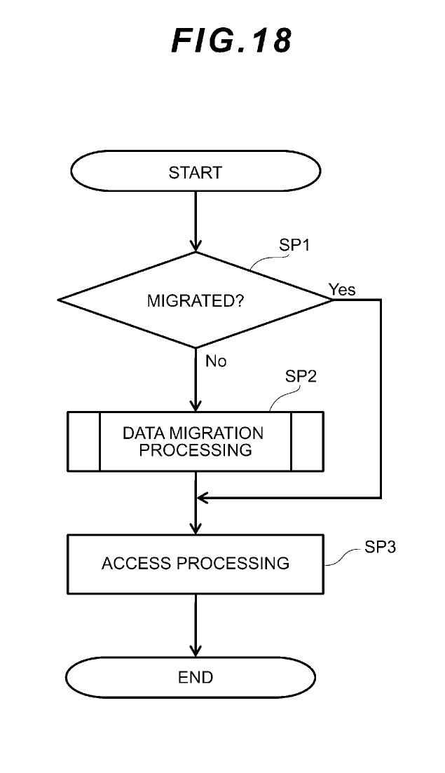

FIG. 18 shows a processing routine for access request execution processing which is executed by the file system program 522 of the migration destination frontend file server 500. The file system program 522 executes the processing of the access request according to the processing routine shown in FIG. 18.

In reality, the file system program 522 starts the access request execution processing upon receipt of an access request (data reading, data writing, or data deletion) which is transmitted by the client computer 100 or an application program (not shown) on the migration destination frontend file server 500.

Here, this access request includes an IP address, a file system path, and an object path as information (hereinafter called target object information) which specifies the target object (hereinafter this is called the target object). The IP address is shown as “192.168.0.3”, the file system path as “/mnt/fs03” and the object path as “/file,” and the target object information is expressed in the format “193.168.0.3:/mnt/fs03/file,” which is a combination of this information.

Further, upon starting this access request execution processing, the file system program 522 first determines whether the object targeted by the received access request at the time (hereinafter called the target object) has been migrated from the migration source storage apparatus 400 to the migration destination frontend storage apparatus 600 or migration destination backend storage apparatus 800 (SP1). When an affirmative result is obtained in this determination, the file system program 522 advances to step SP3.

However, upon receipt of a negative result in the determination of step SP1, by transferring an access request to the data moving program 523, the file system program 522 causes the data moving program 523 to execute data migration processing for migrating the target object from the migration source storage apparatus 400 to the migration destination frontend storage apparatus 600 or migration destination backend storage apparatus 800 (SP2).

The file system program 522 then executes data read processing, data write processing, or data deletion processing according to the access request for the target object migrated from the migration source storage apparatus to the migration destination frontend storage apparatus 600 or migration destination backend storage apparatus 800 (SP3) and subsequently terminates the access request execution processing.

(1-4-2) Data Migration Processing

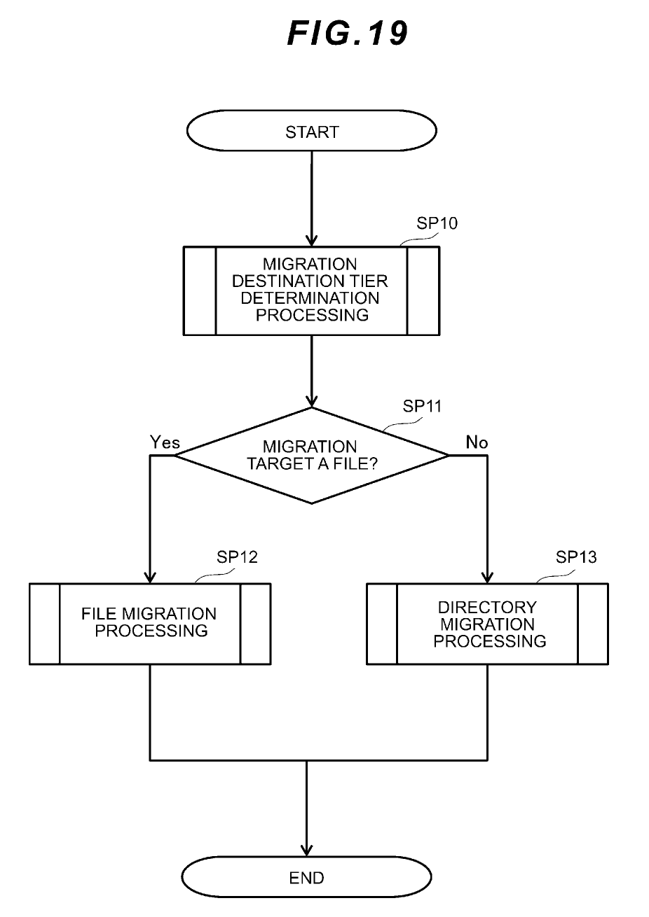

FIG. 19 shows specific processing content for the data migration processing which is executed by the data migration program 524 of the migration destination frontend file server 500 in step SP2 of the access request execution processing (FIG. 18).

In reality, upon advancing to step SP2 of the access request execution processing, the data migration program 524 starts the data migration processing shown in FIG. 19 and first determines the tier which is to serve as the migration destination of the target object (the migration destination frontend storage apparatus 600 or the migration destination backend storage apparatus 800) (SP10).

The data migration program 524 then determines whether the target object is a file (SP11). Further, upon receiving an affirmative result in this determination, the data migration program 524 executes file migration processing to migrate the target object from the migration source storage apparatus 400 to the migration destination frontend storage apparatus 600 or migration destination backend storage apparatus 800 determined as the migration destination in step SP10 (SP12) and then terminates the data migration processing.

If, on the other hand, a negative result is obtained in the determination of step SP11, the data migration program 524 executes directory migration processing in which the target object is duplicated in the migration destination frontend storage apparatus 600 or migration destination backend storage apparatus 800 determined as the migration target in step SP10 (SP13) and then terminates the data migration processing.

(1-4-3) Migration Destination Tier Determination Processing

FIG. 20 shows specific processing content for migration destination tier determination processing which is executed by the data migration program 524 in step SP10 in the data migration processing (FIG. 19). The migration destination tier determination processing is executed by the migration destination tier determination module 524C among each of the modules which form part of the data migration program 524.

In reality, upon advancing to step SP10 of the data migration processing, the migration destination tier determination module 524C starts the migration destination tier determination processing shown in FIG. 20 and first acquires the user ID of the user who transmitted the access request for the target object by means of the process information acquisition program 526 (SP20).

The migration destination tier determination module 524C then acquires the tier to which the target object is to be migrated (migration destination frontend storage apparatus 600 or migration destination backend storage apparatus 800) on the basis of the user ID and migration policy definition table 529 (FIG. 15) acquired in step SP20 (SP21).

The migration destination tier determination module 524C then determines whether the tier to which the target object is to be migrated was acquired in step SP21 (SP22).

Obtaining an affirmative result in this determination means that, if an access request is supplied from the user, which tier the target object is to be migrated to is preconfigured. Thus, the migration destination tier determination module 524C then terminates the migration destination tier determination processing.

However, obtaining a negative result in the determination of step SP22 means that, if an access request is supplied from the user, which tier the target object is to be migrated to has not been preconfigured. The migration destination tier determination module 524C thus configures the tier of the target object migration destination as “1” (that is, the migration destination of the target object is configured as the migration destination frontend storage apparatus) (SP23) and subsequently terminates the migration destination tier determination processing.

(1-4-4) File Migration Processing

FIG. 21 shows specific processing content for file migration processing which is executed by the data migration program 524 in step SP12 of the foregoing data migration processing (FIG. 19). This file migration processing is executed by the file migration module 524D among each of the modules which constitute the data migration program 524.

In reality, upon advancing to step SP12 of the data migration processing, the file migration module 524D starts the file migration processing shown in FIG. 21, first refers to the migration configuration definition table 530 (FIG. 16), acquires the IP address and the corresponding file system path of the file server (the migration destination frontend file server 500 or migration destination backend file server 700) managing the tier serving as the migration destination of the target object determined in step SP10, and creates a new path (hereinafter called a migration destination path) on the basis of the acquired IP address and file system path (SP30).

More specifically, the file migration module 524D searches, among the entries in the migration configuration definition table 530, for an entry storing a category “migration destination” in the category field and storing, in the tier field, a numerical value representing the migration destination tier of the target object determined in step SP10 in FIG. 19, and acquires the IP address stored in the IP address field of the entry and the file system path stored in the file system path field of the entry. Further, the file migration module 524D generates, as the migration destination path, a path which is in the format “192.168.0.4:/mnt/fs04/file”, which is a combination of these values and the file path (/file) of the target object (file).

The file migration module 524D then determines whether the migration destination tier of the target object is “2” (that is, whether the migration destination of the target object is the migration destination backend storage apparatus) (SP31). Further, upon obtaining a negative result in this determination, the file migration module 524D advances to step SP33.

When, on the other hand, a negative result is obtained in the determination of step SP61, the file migration module 524D supplies an instruction (hereinafter called the stub file creation instruction) to the stub file creation module to create a stub file storing information on the migration destination of the target object (SP32).

The file migration module 524D subsequently creates a new file (hereinafter called a migration destination file) in the migration destination path created in step SP30 by means of the file creation module 522A, 722A of the migration destination frontend file server 500 or migration destination backend file server 700 (SP33) and subsequently duplicates the metadata of the target object (file) as migration destination file metadata, in the migration destination frontend file server 500 or the migration destination backend file server 700 (SP34).

More specifically, the file migration module 524D calls the object metadata read module 322C of the migration source file server 300 in step SP34, and reads and transfers the metadata of the target object. Further, the file migration module 524D then duplicates the target object metadata by means of the object metadata write module 522D, 722D of the migration destination frontend file server 500 or migration destination backend file server 700 and stores the target object metadata in the migration destination file created in step SP33.

The file migration module 524D then reads real data from the target object by means of the object data read module 322E of the migration source file server 300. Further, the file migration module 524D duplicates the real data of the target object by means of the object data write module 522F, 722F of the migration destination frontend file server 500 or migration destination backend file server 700 and stores the real data in the migration destination file created in step SP63 (SP35). Furthermore, the file migration module subsequently terminates the file migration processing.

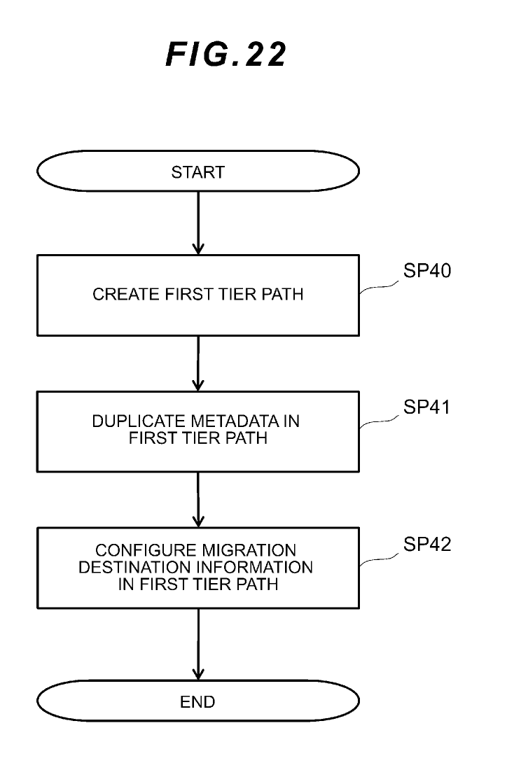

Note that FIG. 22 shows specific processing content of the stub file creation processing which is executed by the stub file creation module 524F of the data migration program 524 of the migration destination frontend file server 500 in step SP32 of the file migration processing.

When a stub file creation instruction is supplied from the file migration module 524D in step SP32 of the file migration processing, the stub file creation module 524F starts the stub file creation processing shown in FIG. 22 and first refers to the migration configuration definition table to create a first tier path (SP40). Here, first tier path denotes the path of a stub file representing the migration destination path. The first tier path is a path which has the same file path as the migration destination path, for example, and has a different file system path and IP address, for example, the IP address “192.168.0.3:/” and the file system path “/mnt/fs03” are denoted as the IP address “192.168.0.4:/” and the file system path “/mnt/fs04” which represent the migration destination path, and a path in the format “192.168.0.4:/mnt/fs04/file,” which combines this information with the file path (/file) of the target object (file), is generated as the migration destination path.

The stub file creation module 524F subsequently duplicates the target object (file) metadata in the migration destination frontend file server 500 as the migration destination file metadata by means of the object metadata read module 322C of the migration source file server 300 (SP41).

More specifically, the stub file creation module 524F calls the object metadata read module 522C of the migration destination frontend file server 500 in step SP41 and reads and transfers the metadata of the target object. Furthermore, the stub file creation module 524F duplicates the metadata of the target object by means of the object metadata write module 522D of the migration destination backend file server 700 and stores the metadata in the position of the migration destination path created in step SP40.

The stub file creation module 524F subsequently stores information which indicates the storage destination in the migration destination backend file server 700 of the target object in the position of the migration destination path created in step SP40 (SP42). Further, the stub file creation module 524F subsequently terminates the stub file creation processing.

(1-4-5) Directory Migration Processing

FIG. 23 shows specific processing content of the directory migration processing which is executed by the data migration program 524 in step SP13 of the data migration processing (FIG. 19). This directory migration processing is executed by the directory migration module 524E among the modules constituting the data migration program 524.

In reality, upon advancing to step SP13 of the data migration processing, the directory migration module 524E starts the directory migration processing shown in FIG. 23 and first generates a migration destination path by processing step SP50 in the same way as step SP30 of the file migration processing mentioned earlier in FIG. 21 (SP50).

The directory migration module 524E then creates a new directory (hereinafter called a migration destination directory) (SP51) in the migration destination path created in step SP30 by means of the directory creation module 522B, 722B of the migration destination frontend file server 500 or migration destination backend file server 700 (SP51) and subsequently duplicates, as metadata of the migration destination file, the metadata of the target object (directory) in the migration destination frontend file server 500 or migration destination backend file server 700 (SP52).

More specifically, the directory migration module 524E calls the object metadata read module 322C of the migration source file server 300 in step SP52 and reads and transfers the metadata of the target object. Furthermore, the file migration module 524D duplicates the metadata of the target object by means of the object metadata write module 522D, 722D of the migration destination frontend file server 500 or migration destination backend file server 700 and stores the metadata in the migration destination directory created in step SP51.

The directory migration module 524E subsequently reads the real data from the target object by means of the object data read module 322E of the migration source file server 300. Further, the directory migration module 524E duplicates the real data of the target object by means of the object data write module 522F, 722F of the migration destination frontend file server 500 or the migration destination backend file server 700, and stores the data duplicated in the directory created in step SP71 (SP53). Further, the directory migration module 524E subsequently terminates the directory migration processing.

(1-4-6) Metadata Update Processing

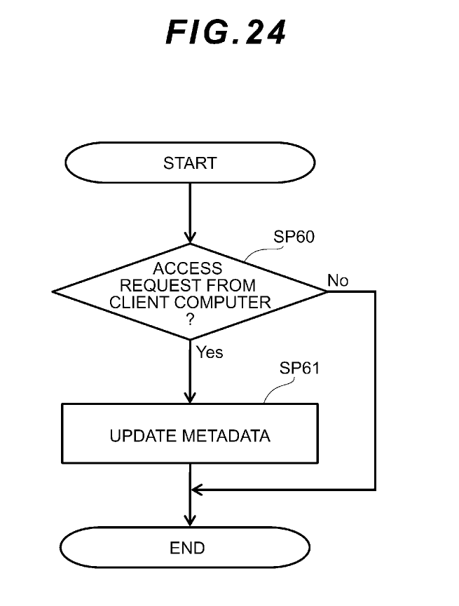

FIG. 24 shows a processing routine of metadata update processing which is executed by the file system program 522 of the migration destination frontend file server 500. The file system program 522 executes an update of the metadata of the target object according to the processing routine shown in FIG. 24.

In reality, the file system program 522 starts the metadata update processing upon receipt of an access request (data read, data write, or data deletion) which is transmitted from the client computer 100 or an application program (not shown) on the migration destination frontend file server 500.

Here, this access request contains an IP address, file system path, and object path as target object information specifying the target object.

Furthermore, upon starting the metadata update processing, the file system program 522 first acquires the user ID of the user that transmitted the access request for the target object by means of the process information acquisition program 526 and determines from the acquired user ID whether the transmission source of the access request is a request from the user (SP60).

Obtaining a negative result in this determination means that the access request transmission source is accessed by a system. Thus, the file system program 522 then terminates the metadata update processing.

If, however, an affirmative result is obtained in the determination of step SP60, the file system program 522 terminates the metadata update processing after executing an update of the target object metadata (SP61).

(1-4-7) Data Moving Processing

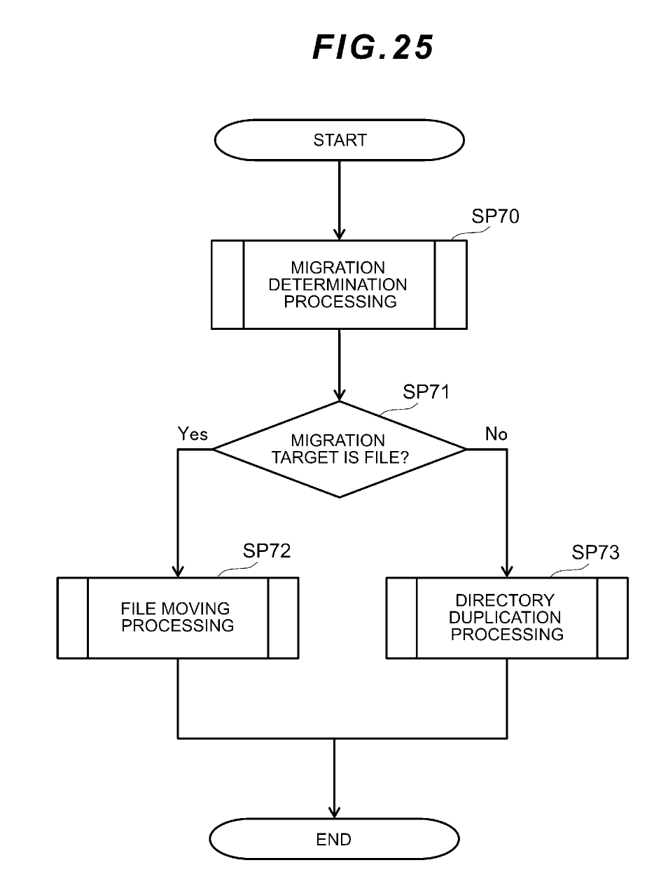

FIG. 25 shows a processing routine for data moving processing which is executed by the data moving program 523 of the migration destination frontend file server 500. The data moving program 523 executes the data moving processing which moves the target object from the migration destination frontend file server 500 to the migration destination backend file server 700 according to the processing routine shown in FIG. 25.

In reality, upon receiving the data moving request which is transmitted from an application program (not shown) on the migration destination frontend file server 500, the data moving program 523 starts the data moving processing.

Here, this data moving request contains an IP address, a file system path, and object path as target object information specifying the target object.

Furthermore, upon starting the data moving processing, the data moving program 523 first determines the tier (migration destination frontend storage apparatus 600 or the migration destination backend storage apparatus 800) which is to serve as the moving destination of the target object of the data moving request at the time in the received data moving request (SP70).

The data moving program 523 subsequently determines whether the target object is a file (SP71). Furthermore, upon obtaining an affirmative result in this determination, in cases where the migration destination backend storage apparatus 800 is determined to be the moving destination in step SP70, the data moving program 523 executes file moving processing to move the target object from the migration destination frontend storage apparatus 600 to the migration destination backend storage apparatus 800 (SP72), and subsequently terminates the data moving processing.

If, however, a negative result is obtained in the determination of step SP71, if the migration destination backend storage apparatus 800 is determined as the moving destination in step SP70, the data moving program 523 executes directory migration processing which duplicates the target object from the migration destination frontend storage apparatus 600 to the migration destination backend storage apparatus 800 (SP73) and subsequently terminates the data moving processing.

(1-4-8) Moving Determination Processing

FIG. 26 shows specific processing content of the data moving processing which is executed by the data moving program 523 of the migration destination frontend file server 500 in step SP70 of the data moving processing (FIG. 25). The data moving processing is executed by the migration determination module 523C among each of the modules constituting the data moving program 523.

In reality, upon advancing to step SP70 of the data moving processing, the migration determination module 523C starts the moving determination processing shown in FIG. 26 and first acquires the last access time of access to the object by the user on the basis of object metadata of the target object by means of the object metadata read module 522C (SP80).

The migration determination module 523C then acquires the tier to which the target object is to be moved (the migration destination frontend storage apparatus 600 or the migration destination backend storage apparatus 800) on the basis of the last access time and the tier moving policy definition table 527 (FIG. 13) acquired in step SP80 (SP81).

The migration determination module 523C then determines whether a tier to which the target object is to be moved in step SP81 (SP82).

Obtaining the affirmative result in the determination means that, if a data moving request, which is transmitted from an application program (not shown) on the migration destination frontend file server 500, is supplied by the user, which tier the target object is to be moved to is preconfigured. Thus, the moving determination module 523C thus terminates the migration determination processing.

Obtaining a negative result in the determination of step SP82 means that, if a data moving request, which is transmitted from an application program (not shown) on the migration destination frontend file server 500, is supplied by the user, which tier the target object is to be moved to has not been preconfigured. Thus, the moving determination module 523C terminates the moving determination processing after configuring the placement destination tier of the target object as “1” (that is, configuring the moving destination of the target object as the migration destination frontend storage apparatus) (SP83) and terminates the moving determination processing.

(1-4-9) File Moving Processing

FIG. 27 shows specific processing content of file moving processing which is executed by the data moving program 523 in step SP72 of the data moving processing (FIG. 25). The file moving processing is executed by the file moving module 523D among each of the modules constituting the data moving program 523.

In reality, upon advancing to step SP72 in the data moving processing, the file moving module 523D starts the file moving processing shown in FIG. 27 and first determines whether the moving destination tier of the target object is “2” (that is, whether the target object moving destination is a migration destination backend storage apparatus 800) (SP90). Upon obtaining a negative result in this determination, the file migration module 524D terminates the file moving processing.

If, on the other hand, an affirmative result is obtained in the determination of step SP90, the file moving module 523D refers to the tier configuration definition table 528 (FIG. 14), acquires the IP address and corresponding file system path of the file server managing the tier which is to serve as the moving destination of the target object determined in step SP70 (the migration destination frontend file server 500 or migration destination backend file server 700), and generates a new path (hereinafter called the moving destination path) on the basis of the acquired IP address and file system path (SP91).

More specifically, the file moving module 523D searches, among the entries in the tier configuration definition table 528, for an entry storing a numerical value representing the moving destination tier of the target object determined in step SP70 in FIG. 25 in the tier field, and acquires the IP address stored in the IP address field of the entry and the file system path stored in the file system path field of the entry. Further, the file moving module 523D generates, as the moving destination path, a path which is in the format “192.168.0.4:/mnt/fs04/file”, which is a combination of these values and the file path (/file) of the target object (file).

The file moving module 523D then creates a new file (hereinafter called a moving destination file) in the moving destination path created in step SP91 by means of the file creation module 722A of the migration destination backend file server 700 (SP92) and subsequently duplicates the metadata of the target object (file) in the migration destination backend file server 700 as metadata of the moving destination file (SP93).

More specifically, the file moving module 523D calls the object metadata read module 522C of the migration destination frontend file server 500 in step SP93 and reads and transfers the target object metadata. Further, the file moving module 523D then duplicates the metadata of the target object by means of the object metadata write module 722D of the migration destination backend file server 700 and stores the metadata in the moving destination file which is created in step SP92.

The file moving module 523D then reads real data from the target object by means of the object data read module 522E of the migration destination frontend file server 500. The file moving module 523D duplicates the real data of the target object by means of the object data write module 722F of the migration destination backend file server 700 and stores the real data in the moving destination file created in step SP92 (SP94). The file moving module 523D subsequently terminates the file moving processing.

Furthermore, the file moving module 523D deletes target object data by means of the object data deletion module 322G of the migration destination backend file server 700. The file moving module 523D stores information (second data) indicating the migration destination in the migration destination backend file server 700 of the target object in the position of the moving destination path created in step SP92 (SP95). Further, the file moving module 523D subsequently terminates the file moving processing.

(1-4-10) Directory Duplication Processing

FIG. 28 shows specific processing content of the directory duplication processing which is executed by the data moving program 523 in step SP73 of the data moving processing (FIG. 25). The directory duplication processing is executed by the directory duplication module 523E among each of the modules constituting the data moving program 523.

In reality, upon advancing to step SP73 of the data moving processing, the directory duplication module 523E starts the directory moving processing shown in FIG. 28 and generates the moving destination path by processing steps SP100 and SP101 in the same way as steps SP90 and SP91 of the file moving processing described earlier in FIG. 19.

The directory duplication module 523E subsequently creates a new directory (hereinafter called the moving destination directory) in the moving destination path created in step SP101 by means of the directory creation module 722B of the migration destination backend file server 700 (SP102) and then duplicates the metadata of the target object (directory) in the migration destination frontend file server 500 or migration destination backend file server 700 as metadata of the migration destination file (SP103).

More specifically, the directory duplication module 523E calls the object metadata read module 522C of the migration destination frontend file server 500 in step SP103 and reads and transfers the target object metadata. Further, the directory duplication module 523E duplicates the metadata of the target object by means of the object metadata write module 722D of the migration destination backend file server 700 and stores the metadata in the moving destination directory created in step SP102.

The directory duplication module 523E then reads real data from the target object by means of the object data read module 522E of the migration destination frontend file server 500. Furthermore, the directory duplication module 523E duplicates the real data of the target object by means of the object data write module 722F of the migration destination backend file server 700 and stores the duplicated data in the directory created in step SP102 (SP104). Furthermore, the directory duplication module 523E terminates the directory duplication processing.

(1-5) Effect of the Embodiment

With the foregoing embodiment, it is determined whether the data access to data stored in the migration source storage apparatus 400 is a request from the migration destination frontend file server 500 or from the user and, if the request is from the migration destination frontend file server 500, the data of the access target is migrated from the migration source storage apparatus 400 to the migration destination backend storage apparatus 800, whereas if the request is from the user, the data is migrated to the migration destination frontend storage apparatus 600, and therefore if migration processing is executed for data for which a high speed response to the user is required, the target data can be stored in a storage apparatus with a high-speed and high-cost storage area, thereby improving the response performance to the data access request from the user.

### (2) Second Embodiment

(2-1) Configuration of Computer System According to this Embodiment

In FIGS. 1 and 29, 1100 refers to the whole computer system according to a second embodiment. The computer system 1100 is configured similarly to the computer system 1 according to the first embodiment except that bandwidth (hereinafter called network bandwidth) that is available to the network 900 which is used when executing data migration is allocated by a data migration program 1122 of a migration destination frontend file server 1110 according to priority on the basis of data access by the migration destination frontend file server 500 or data access by the user, and access request execution processing is performed according to this priority, in addition to [the program 1122] migrating the access target data from the migration source storage apparatus 400 to the migration destination frontend storage apparatus 600 if the migration destination frontend file server 500 executes data access to data stored in the migration source storage apparatus 400 in the computer system 1 and migrating the access target data from the migration source storage apparatus 400 to the migration destination backend storage apparatus 800 if the user executes data access.

In reality, according to the first embodiment, the data migration program 524 of the migration destination frontend file server 500 executes the data migration processing without considering network bandwidth availability.

However, when there is an increase in the network bandwidth used to access data for which a high speed response to the user is not required, for example, a situation arises where there is little network bandwidth that is used to migrate data requiring a high speed response.

Therefore, in the case of this embodiment, the data migration program 1122 determines the priority for the system administrator beforehand for each of the users executing data access to the data stored in the migration source storage apparatus 400 and the user IDs of the applications of the migration destination frontend file server 1110, and executes data migration processing which performs data migration by using the network bandwidth allocated based on these priorities.

In reality, the file server program 1121 of the migration destination frontend file server 1110 measures the network bandwidth which is used for each of the users or migration destination frontend file servers 1110 while objects are being migrated from the migration source storage apparatus 400 to the migration destination frontend storage apparatus 600 or migration destination backend storage apparatus 800.

Further, the data migration program 1122 compares the value measured by the file server program 1121 with the value of the network bandwidth allocated based on the priority, and executes data migration processing if the measured value lies within the range of the assigned network bandwidth.

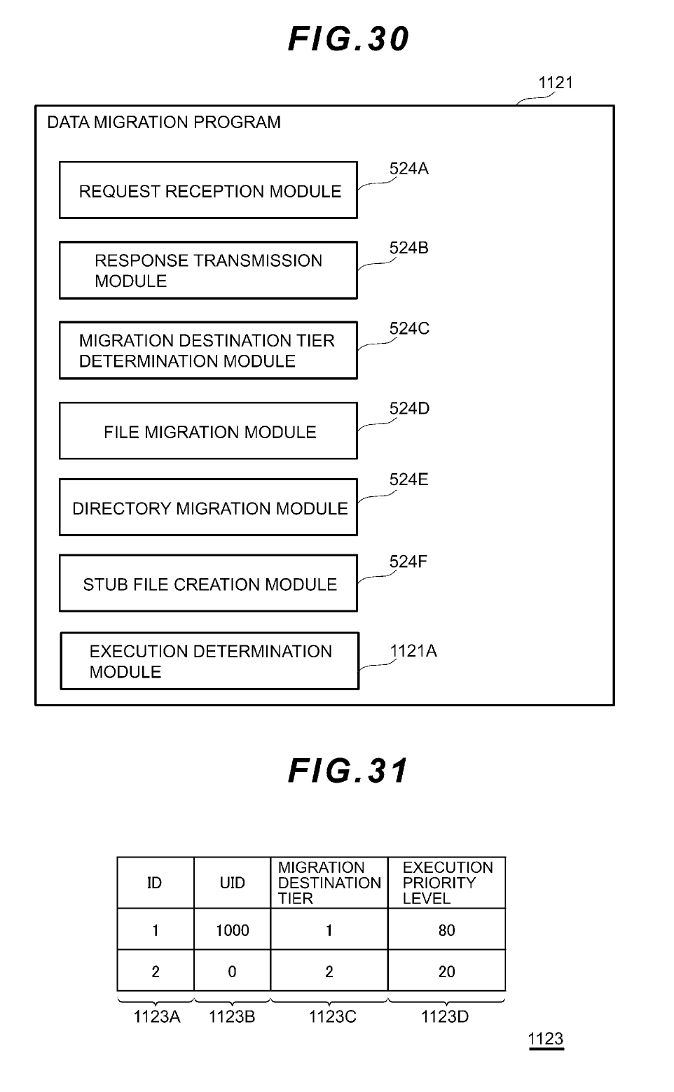

Furthermore, the data migration program 1122 comprises, as shown in FIG. 30, a request reception module 524A, a response transmission module 524B, a migration destination tier determination module 524C, a file migration module 524D, a directory migration module 524E, a stub file creation module 524F, and an execution determination module 1122A. The data migration program 1122 differs from the data migration program 524 of the first embodiment in that the execution determination module 1122A is included.

Note that the execution determination module 1122A is a program for checking the unused network bandwidth status, comparing this bandwidth with the pre-assigned available network bandwidth, and determining whether to execute data migration processing.

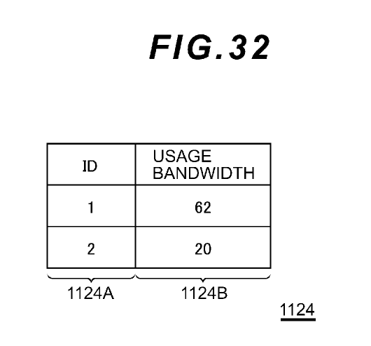

As means for implementing the foregoing data migration processing according to this embodiment, a memory 1120 of the migration destination frontend file server 1110 stores a migration policy definition table 1123 shown in FIG. 31 and a bandwidth information table 1124 shown in FIG. 32 in addition to the tier moving policy definition table 527 (FIG. 13), the tier configuration definition table 528 (FIG. 14), the migration policy definition table 529 (FIG. 15) and the migration configuration definition table 530 (FIG. 16) which were described earlier in the first embodiment.

This migration policy definition table 1123 is a table which is used to manage policies which are migration conditions for when an object is migrated from the migration source file server 300 to the migration destination frontend file server 500 and which are pre-registered in the migration destination frontend file server 500 via the management terminal 200 by the system administrator and, as shown in FIG. 31, the table is configured from an ID field 1123A, a user ID field 1123B, a migration destination tier field 1123C, and an execution priority field 1123D.

Further, the user ID field 1123B stores user identifiers (user IDs) which are assigned to the user and migration destination frontend file server 1110 which accesses the corresponding object and the migration destination tier field 1123C stores the migration destination of the corresponding object. In addition, the execution priority level field 1123D stores percentages for the execution priority levels of the network bandwidths to be used when migrating the target object to the corresponding user ID, and the ID field 1123A stores identifiers (hereinafter called migration policy identifiers) assigned to the corresponding user IDs, migration destination tiers and execution priority levels.

Therefore, the example in FIG. 31 shows that an object for which access is requested by the user with the user ID “1000” or migration destination frontend file server 1110 is stored in a tier “1” storage apparatus and that the migration policy identifier of a migration policy with a processing execution priority level of “80” is “1”.

Meanwhile, the bandwidth information table 1124 is a table which is used to manage a network usage bandwidth that is used for each user and migration destination frontend file server 1110 that accesses an object when the object is migrated from the migration source file server 300 to the migration destination frontend file server 500 and, as shown in FIG. 32, is configured from an ID field 1124A and usage bandwidth field 1124B.

Further, the ID field 1124A stores corresponding migration policy identifiers and the used bandwidth field 1124B stores usage bandwidth values indicating the usage states of the network bandwidths assigned to the corresponding migration policy identifiers.

Hence, FIG. 32 shows that the available usage bandwidth of the network 900 to which the migration policy identifier “1” is assigned is “62.”

(2-2) Migration Policy Configuration Screen

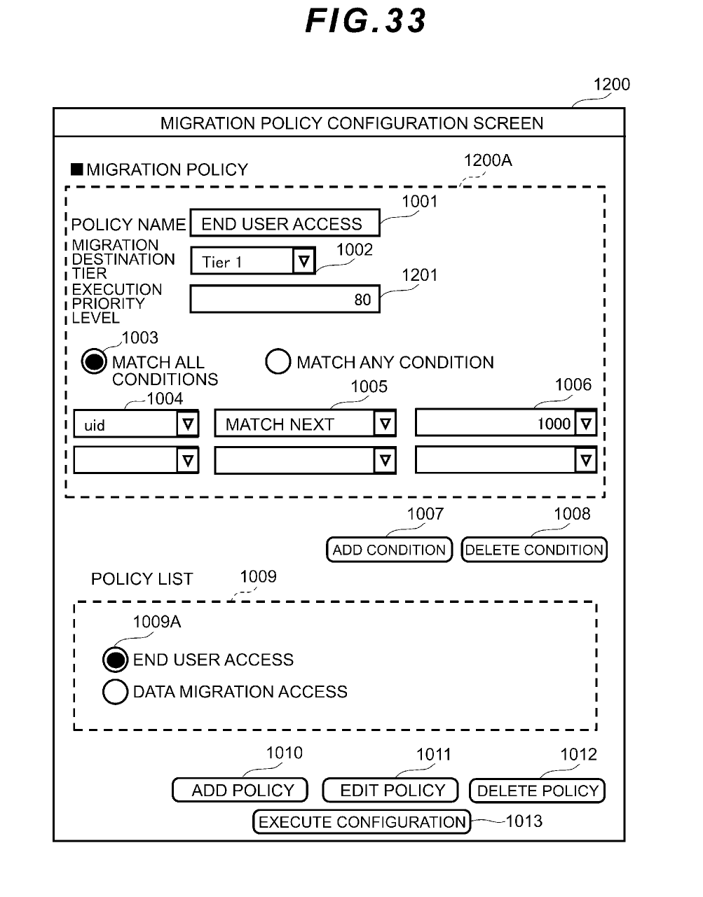

FIG. 33 shows an example of the configuration of a migration policy configuration screen 1200 which is displayed on an information output device, not shown, of the management terminal 200 as a result of the system administrator operating the management terminal 200. The system administrator is able to use the migration policy configuration screen 1200 to create a new policy, which is a migration condition when migrating an object, on the migration destination frontend file server 1110.

Note that the migration policy configuration screen 1200 according to this embodiment has the same configuration as the migration policy configuration screen 1000 described earlier in FIG. 17 except that an execution priority level display area 1201 is provided in a migration policy display area 1200A.

The execution priority level display area 1201 in the migration policy display area 1200A is a display area for displaying a value for the execution priority level that is entered by the system administrator.

Accordingly, FIG. 33 shows an example of a screen display for when the system administrator creates a policy for end user access when the user ID matches “1000” in which storage is in a migration destination tier “Tier 1” and the execution priority level is “80.” Further, the system administrator is then able, by clicking a configuration execution button 1013, to create this policy in the memory 1120 of the migration destination frontend file server 1110.

(2-3) Data Migration Processing According to this Embodiment

A processing routine for data migration processing according to this embodiment will be described next. Note that the data migration processing which is executed in step SP2 of the access request execution processing (FIG. 18) according to the first embodiment differs from the data migration processing according to this embodiment but otherwise the same processing as the access request execution processing according to the first embodiment is performed.

(2-3-1) Data Migration Processing

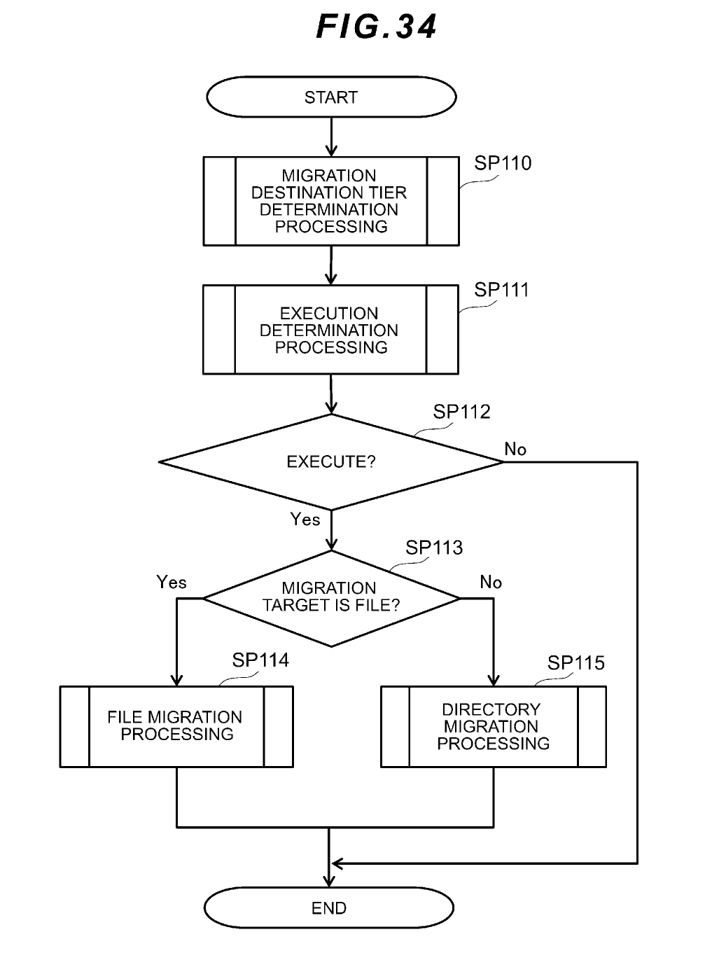

FIG. 34 shows a processing routine for the data migration processing which is executed by the data migration program 1122 of the migration destination frontend file server 1110. The data migration program 1122 executes data migration according to the processing routine shown in FIG. 34.

In reality, upon advancing to step SP2 of the access request execution processing, the data migration program 1122 starts the data migration processing shown in FIG. 19 and first determines the storage area tier of the storage apparatus in which the target object is to be stored by processing step SP110 in the same way as step SP10 of the data migration processing described earlier in FIG. 19 (SP110).

The data migration program 1122 executes checks the unused network bandwidth status, compares this bandwidth with the pre-assigned available network bandwidth, and executes execution determination processing to determine whether to execute data migration processing (SP111).

The data migration program 1122 then determines whether to execute target object data migration processing (SP112). Upon obtaining a negative result in the determination, the data migration program 1122 terminates the data migration processing.

If, on the other hand, an affirmative result is obtained in the determination of step SP92, the data migration program 1122 terminates the data migration processing after processing steps SP113 to SP115 in the same way as steps SP11 to SP13 in the data migration processing described earlier in FIG. 19.

(2-3-2) Execution Determination Processing

FIG. 33 shows specific processing content of the execution determination processing which is executed by the data migration program 1122 of the migration destination frontend file server 1110 in step SP111 of the foregoing data migration processing (FIG. 34). The execution determination processing is executed by the execution determination module 1122A among each of the modules constituting the data migration program 1122.

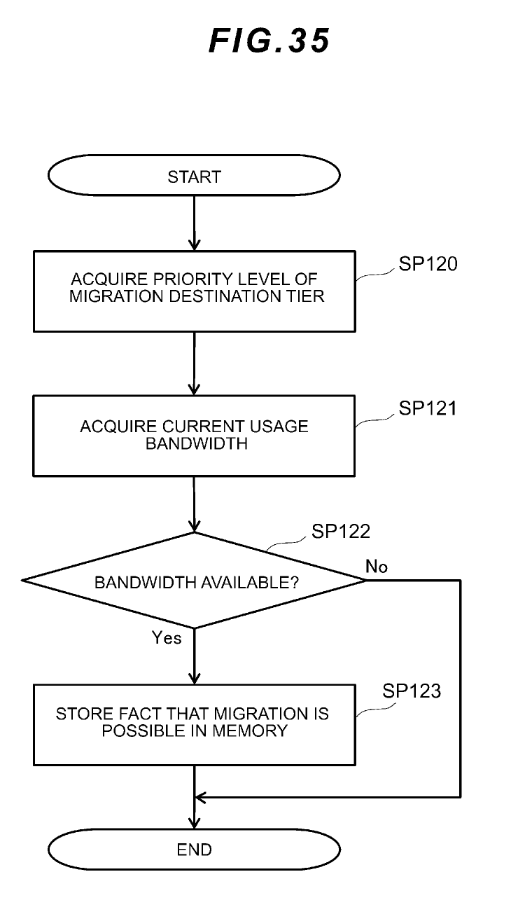

In reality, upon advancing to step SP111 of the data migration processing, the execution determination module 1122A starts the execution determination processing shown in FIG. 35 and first acquires the user ID of the user who transmitted the access request for the target object by means of the process information acquisition program 526 and, based on the acquired user ID and the migration policy definition table 1123 (FIG. 31), acquires the execution priority level of the network bandwidth to be used when migrating the target object (SP120).

Furthermore, the execution determination module 1122A acquires the usage bandwidth representing the network bandwidth usage state to be used when executing data access to the target object on the basis of the acquired user ID and the bandwidth information table 1124 (FIG. 32) (SP121).

The execution determination module 1122A determines whether the value of the usage bandwidth acquired in step SP121 is greater than the network bandwidth assigned when migrating the target object and calculated on the basis of the execution priority level acquired in step SP120 (SP122).

Note that, supposing that the available bandwidth of the network of the data migration program 1122 preconfigured by the system administrator is X and the value of the execution priority level is Y, the value Z of the available network bandwidth assigned based on the priority level is calculated by the following equation.

Math 1

Z=X*Y/100 (1)

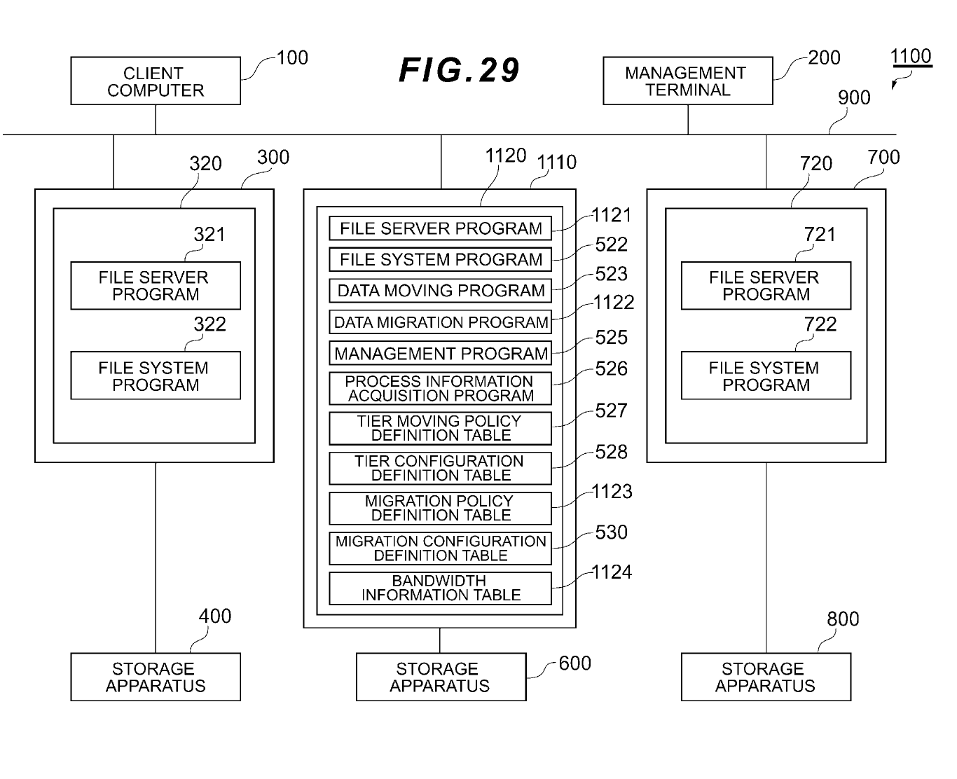

For example, in a case where the bandwidth available to the data migration program 1122 is configured by the system administrator as 100 (MB/s), the bandwidth that can be used by the user in the migration policy definition table 1123 (FIG. 29) is 80 (MB/s).

Further, obtaining an affirmative result in the determination of step SP122 means that the network bandwidth has no available bandwidth of a size suitable for performing data migration processing. The execution determination module 1122A thus then terminates the execution determination processing.

If, on the other hand, a negative result is obtained in the determination of step SP122, this means that the network bandwidth still has available bandwidth of a size suitable for performing data migration processing. At this time, the execution determination module 1122A terminates the execution determination processing after storing the fact that migration is possible in the memory 1120 (SP123).

(2-4) Effect of this Embodiment

With the embodiment as described hereinabove, a determination is made of whether the data access to the data stored in the migration source storage apparatus 400 is a request from the migration destination frontend file server 1110 or a request from the user and, if the request is a request from the migration destination frontend file server 1110, the access target data is migrated from the migration source storage apparatus 400 to the migration destination backend storage apparatus 800, whereas, if the request is a request from the user, the data is migrated to the migration destination frontend storage apparatus 600, and hence in a case where migration processing is executed for data requiring a high speed response to the user, the bandwidth of the network 900 which is used when migrating the target data can be preferentially assigned in a large amount, thereby improving the response performance to an access request from the user to access data.

### (3) Further Embodiments

Note that a case was described in the foregoing embodiment in which the client computer 100, the management terminal 200, the migration source file server 300, the migration destination frontend file server 500, and the migration destination backend file server 700 are each connected via a LAN (Local Area Network) 90, but the present invention is not limited to this case, rather, a SAN (Storage Area Network) may also be used or the foregoing components may be directly connected.

In addition, a case was described in the foregoing embodiment in which the migration source storage apparatus (first storage apparatus) 400 is connected to the migration source file server 300 (first file server), the migration destination frontend storage apparatus (second storage apparatus) 600 is connected to the migration destination frontend file server 500 (second file server), and the migration destination backend storage apparatus (third storage apparatus) 800 is connected to the migration destination backend file server 700 (third file server), via the network 900, but the present invention is not limited to such a case, rather, the migration source storage apparatus 400 and migration source file server 300 may also be integrated as a single apparatus such as a NAS (Network Attached Storage), for example. In addition, the migration destination frontend storage apparatus 600 and migration destination frontend file server 500, and the migration destination backend storage apparatus 800 and migration destination backend file server 700 may also be similarly integrated as a single apparatus.

Further, a case was described in the foregoing embodiment in which the data moving processing for migrating the target object from the migration destination frontend storage apparatus 600 to the migration destination backend storage apparatus 800 is started as a result of the application program on the migration destination frontend file server 500 transmitting a data moving request, but the present invention is not limited to such a case, rather, for example, the data moving processing may also be started as a result of the management terminal 200 transmitting a data moving request including an IP address, a file system path, and an object path to the migration destination frontend file server 500.

Furthermore, although a case was described in the foregoing embodiment in which data for which there is an access request from the client computer 100 is migrated to the migration destination frontend file server 500 and data for which there is an access request from the application on the migration destination frontend file server 500 is migrated to the migration destination backend file server 700, the present invention is not limited to such a case; for example, only data for which there is an access request from a certain client computer 100 among a plurality of client computers 100 may be migrated to the migration destination frontend file server 500, or data for which there is an access request not from the application on the migration destination frontend file server 500 but, rather, data for which there is an access request from the application operating on a server other than the migration destination frontend file server 500 may be migrated.

In addition, although a case was described in the foregoing embodiment where metadata representing data attribute information such as the last access time is stored in the tier moving policy definition table (first table) and where a condition is established for determining whether to perform data migration of the last access time from the migration destination frontend file server 500 to the migration destination backend file server 700, the present invention is not limited to such a case, rather, for example, a determination may be made regarding whether to perform data migration based on the last modification time, the object creation time, or object data content such as a document or photograph.

Furthermore, although a case was described in the foregoing embodiment in which data migration is performed from the migration source storage apparatus 400 which comprises a storage area (first storage area) to storage areas with a two-tier structure (second and third storage areas) which are configured by the migration destination frontend storage apparatus 600 and the migration destination backend storage apparatus 800, the present invention is not limited to such a case, rather, for example, the storage area of the migration source storage apparatus 400 may also have a tiered structure and data may be migrated from the migration source storage apparatus 400 which has a tier configuration to the migration destination frontend storage apparatus 600 and migration destination backend storage apparatus 800.

In addition, although a case was described in the foregoing embodiment in which data migration is performed to a storage area with a two tier structure which is configured from the migration destination frontend storage apparatus 600 and the migration destination backend storage apparatus 800, the present invention is not limited to such a case, rather, data migration may also be performed to a storage area with a structure of three or more tiers, for example.

Furthermore, although a case was described in the foregoing embodiment in which the priority level is determined by the system administrator beforehand for the user executing data access to the data stored in the migration source storage apparatus 400 or for the user ID of the application of the migration destination frontend file server 1110, and in which the data migration program 1122 performs data migration by using the network bandwidth which is assigned on the basis of the priority level, the present invention is not limited to such a case, rather, data migration may also be performed by assigning an access count to the frontend file server on the basis of the priority level, for example.

In addition, although a case was described in the foregoing embodiment in which the system administrator configures the priority level for the user or application on the migration destination frontend file server 1110 executing data access to the data stored in the migration source storage apparatus 400, the present invention is not limited to such a case, rather, the priority level may also be changed according to time zone, for example.

Moreover, although a case was described in the foregoing embodiment in which a bandwidth (first bandwidth) of the network 900 used by the migration destination frontend file server 1110 is acquired in response to an access request from the client computer 100 and a bandwidth (second bandwidth) of the network 900 used by the migration destination frontend file server 1110 is acquired in response to an access request from the application on the migration destination frontend file server 1110, and in cases where the respective bandwidths (first and second bandwidths) are greater than the network bandwidth calculated on the basis of the priority level determined for the client computer 100 and the application on the migration destination frontend file server 1110 respectively, data migration processing is not executed, the present invention is not limited to such a case, rather, data migration may also be executed at a low speed even in a case where, for example, the bandwidths (first and second bandwidths) of the network 900 are greater than the network bandwidth calculated on the basis of the priority level determined beforehand for the client computer 100 and the application on the migration destination frontend file server 1110.

### INDUSTRIAL APPLICABILITY

The present invention can be widely applied to storage apparatuses which comprise storage areas in a tier configuration and to various computer systems configured from file servers which optimally store data according to the characteristics of the storage areas.

### REFERENCE SIGNS LIST

1 Computer system
100 Client computer
200 Management terminal
300 Migration source file server
400 Migration source storage apparatus
310, 510, 710 CPU
320, 520, 720, 1120 Memory
500, 1110 Migration destination frontend file server
600 Migration destination frontend storage apparatus
700 Migration destination backend file server
800 Migration destination backend storage apparatus
900 Network
321, 521, 721 File server program
322, 522, 722 File system program
523 Data moving program
524, 1122 Data migration program
527 Tier moving policy definition table
528 Tier configuration definition table
529, 1123 Migration policy definition table
530 Migration configuration definition table
1124 Bandwidth information table

1. A computer system, comprising:
a client computer;
a first file server which reads and writes data from/to a first storage apparatus which comprises one or more first storage areas;
a second file server which reads and writes data from/to a second storage apparatus which comprises one or more second storage areas; and
a third file server which reads and writes data to a third storage apparatus which comprises a third storage area constituting a tiered structure together with the second storage area,
wherein a client computer or an application on the second file server transmits an access request, for access to data stored in the first storage area, to the second file server,
wherein the second file server migrates the data from the first storage area of the first storage apparatus to the second storage area of the second storage apparatus if the access request from the client computer is received, and
wherein the second file server migrates data from the first storage area of the first storage apparatus to the third storage area of the third storage apparatus if the access request from the application on the second file server is received.

2. The computer system according to claim 1,
wherein the second file server comprises a first table prescribing a condition for moving the data stored in the second storage area to the third storage area, and
the second file server moves the data corresponding to the condition among the data stored in the second storage area to the third storage area on the basis of the first table.

3. The computer system according to claim 2,
wherein the condition is the last access time the data was accessed by the client computer.

4. The computer system according to claim 1,
wherein, if an access request to access the data stored in the first storage area is received from the application on the second file server,
the second file server stores second data representing the migration destination of the data in the second storage area of the second storage apparatus when data is migrated from the first storage area to the third storage area.

5. The computer system according to claim 1, further comprising:
a network interconnecting the first and second file servers,
wherein the second file server assigns, based on priority levels which are preconfigured for the client computer and the application on the second file server respectively, bandwidth of the network that is available to the second file server in response to the access request from the client computer and bandwidth of the network that is available to the second file server in response to the access request from the application on the second file server, and
wherein the second file server migrates data from the first storage area to the second or third storage area in response to the access request from the client computer or the access request from the application on the second file server, within the assigned bandwidth range.

6. The computer system according to claim 5,
wherein the second file server acquires a first bandwidth which is a bandwidth of the network used by the second file server in response to the access request from the client computer, and
wherein the second file server executes data migration if the acquired first bandwidth is smaller than the bandwidth available to the network assigned on the basis of the priority level determined for the client computer.

7. The computer system according to claim 5,
wherein the second file server acquires a second bandwidth which is a bandwidth of the network used by the second file server in response to the access request from the application on the second file server, and
wherein the second file server executes data migration if the acquired second bandwidth is smaller than the bandwidth available to the network assigned on the basis of the priority level determined for the application on the second file server.

8. A data migration method of a computer system which comprises a client computer, a first file server that reads and writes data from/to a first storage apparatus which comprises one or more first storage areas, a second file server that reads and writes data from/to a second storage apparatus which comprises one or more second storage areas, and a third file server that reads and writes data from/to a third storage apparatus which comprises a third storage area constituting a tiered structure together with the second storage area,
the data migration method comprising:
a first step in which the client computer or the application on the second file server transmits an access request, to access the data stored in the first storage area, to the second file server; and
a second step in which, if the access request from the client computer is received, the second file server migrates the data from the first storage area of the first storage apparatus to the second storage area of the second storage apparatus and, if the access request from the application on the second file server is received, the second file server migrates the data from the first storage area of the first storage apparatus to the third storage area of the third storage apparatus.

9. The data migration method according to claim 8,
wherein the second file server comprises a first table that prescribes a condition for moving the data stored in the second storage area to the third storage area, and
wherein, in the second step,
the second file server moves the data which corresponds to the condition among the data stored in the second storage area to the third storage area on the basis of the first table.

10. The data migration method according to claim 9,
wherein the condition is the last access time the data was accessed by the client computer.

11. The data migration method according to claim 8,
wherein, if an access request to access the data stored in the first storage area is received from the application on the second file server in the first step,
the second file server stores, in the second step, second data representing the migration destination of the data in the second storage area of the second storage apparatus when data is migrated from the first storage area to the third storage area.

12. The data migration method according to claim 8,
the computer system further comprising a network interconnecting the first and second file servers,
wherein the second file server assigns, based on priority levels which are preconfigured for the client computer and the application on the second file server respectively, bandwidth of the network that is available to the second file server in response to the access request from the client computer and bandwidth of the network that is available to the second file server in response to the access request from the application on the second file server, and
wherein, in the second step, the second file server migrates data from the first storage area to the second or third storage area in response to the access request from the client computer or the access request from the application on the second file server, within the assigned bandwidth range.

13. The data migration method of the computer system according to claim 12,
wherein, in the second step, the second file server
acquires a first bandwidth which is the bandwidth of the network used by the second file server in response to the access request from the client computer, and
executes data migration if the acquired first bandwidth is smaller than the bandwidth available to the network assigned on the basis of the priority level determined for the client computer.

14. The data migration method of the computer system according to claim 12,
wherein, in the second step, the second file server
acquires a second bandwidth which is the bandwidth of the network used by the second file server in response to the access request from the application on the second file server, and
executes data migration if the acquired second bandwidth is smaller than the bandwidth available to the network assigned on the basis of the priority level determined for the application on the second file server.
